(19) United States
(12) Patent Application Publication
(10) Pub. No.: US 2006/0056037 A1
(43) Pub. Date: Mar. 16, 2006

(54) Projection optical system

(76) Inventor: Tomiei Kuwa, Tokyo (JP)

Correspondence Address: SIDLEY AUSTIN BROWN & WOOD LLP, 717 NORTH HARWOOD, SUITE 3400, DALLAS, TX, 75201, US

(21) Appl. No.: 11/061,261

(22) Filed: Feb. 18, 2005

(30) Foreign Application Priority Data
Feb. 23, 2004 (JP) 2004-046307

(51) Int. Cl. G02B 3/00

(52) U.S. Cl. 359/649

(57) ABSTRACT

A projection optical system for performing enlargement projection from a primary image surface located on the reduction side to a secondary image surface located on the enlargement side has, from the secondary image surface side, at least two reflective surfaces. Of the first and the second reflective surface counted from the secondary image surface side, at least one has a negative optical power. At least one Fresnel reflective surface having a positive or negative optical power is disposed within the entire projection optical system.

This application is based on Japanese Patent Application No. 2004-46307 filed on Feb. 23, 2004, the contents of which are hereby incorporated by reference.

### BACKGROUND OF THE INVENTION

1. Field of the Invention

The present invention relates to a projection optical system, and more particularly to, for example, a projection optical system that has a reflective Fresnel optical element incorporated in an optical construction suitable for rear projection.

2. Description of Related Art

In a projection optical system that performs enlargement projection from a primary image surface located on the reduction side to a secondary image surface located on the enlargement side, disposing a negative mirror closer to the secondary image surface in the optical path is effective in obtaining a wider angle of view. Examples of projection optical systems that use a negative mirror to obtain a wider angle of view are proposed, for example, in Patent Publications 1 to 3 listed below. Patent Publication 1 discloses a projection optical system that achieves rear projection through, from the primary image surface side, a concave mirror that condenses light, a convex mirror that makes light diverge, and a flat mirror that turns the optical path. Patent Publication 2 discloses a projection optical system that achieves rear projection through, from the primary image surface side, four aspherical mirrors that project and image light and one flat mirror that turns the optical path. Patent Publication 3 discloses a projection optical system that achieves rear projection through, from the primary image surface side, a refractive optical lens, a convex mirror, and a flat mirror that turns the optical path. Patent Publication 4 discloses a projection optical system in which a Fresnel mirror is disposed to face the screen surface with a view to realizing a slim projection apparatus.

Patent Publication 1: Japanese Patent Application Laid-Open No. 2002-174853

Patent Publication 2: Japanese Patent Application Laid-Open No. 2002-196413

Patent Publication 3: Japanese Patent Application Laid-Open No. 2003-149744

Patent Publication 4: U.S. Pat. No. 5,274,406

These conventionally proposed projection optical systems, however, have the following disadvantages. The projection optical systems disclosed in Patent Publications 1 to 3 do not contribute to satisfactory slimming-down of projection apparatuses as a whole. Increasing the negative optical power of the mirror helps to obtain a wider angle of view and thus to achieve slimming-down. One problem with this approach is that it produces a strong positive Petzval sum, resulting in poor image surface flatness. Another problem is that the negative mirror, with a curved surface, tends to cause interference when it turns the optical path. On the other hand, in the projection optical system disclosed in Patent Publication 4, distortion is corrected with a Fresnel reflective surface having an original surface convex to the enlargement conjugate surface. The problem here is that the use of the Fresnel reflective surface causes rays to strike the enlargement conjugate surface at sharp angles relative thereto at the periphery of the projected image. This induces surface reflection at the periphery of the screen, resulting in lower brightness there and thus uneven brightness in the projected image.

### SUMMARY OF THE INVENTION

In view of the conventionally encountered problems mentioned above, it is an object of the present invention to provide a projection optical system that, despite offering good optical performance, is advantageous in terms of mass production and cost reduction, is slim, and is composed of lightweight, compact optical components.

To achieve the above object, in one aspect of the present invention, in a projection optical system that performs enlargement projection from a primary image surface located on the reduction side to a secondary image surface located on the enlargement side and that is provided with, from the secondary image surface side, at least two reflective surfaces, of the first and second reflective surfaces counted from the secondary image surface side, at least one has a negative optical power, and at least one Fresnel reflective surface having a positive or negative optical power is disposed within the entire projection optical system.

In another aspect of the present invention, a projection optical system for projecting, while enlarging, the image formation surface of a light valve, which forms a two-dimensional image, onto a screen surface is provided with: a flat mirror for turning the optical path; and a Fresnel mirror having an optical power and disposed on the image formation surface side of the flat mirror.

In still another aspect of the present invention, a projection optical system for projecting, while enlarging, an image formation surface of a light valve, which forms a two-dimensional image, onto a screen surface is provided with: a Fresnel reflective surface having a positive optical power; and a reflective surface having an optical power.

### BRIEF DESCRIPTION OF THE DRAWINGS

FIG. 1 is a side view showing the optical construction of a first embodiment (Example 1) of the invention;

FIG. 2 is a side view showing the optical construction of a second embodiment (Example 2) of the invention;

FIG. 3 is a side view showing the optical construction of a third embodiment (Example 3) of the invention;

FIG. 4 is a side view showing the optical construction of a fourth embodiment (Example 4) of the invention;

FIG. 5 is a side view showing the optical construction of a fifth embodiment (Example 5) of the invention;

FIG. 6 is an enlarged view of a principal portion of FIG. 1;

FIG. 7 is an enlarged view of a principal portion of FIG. 2;

FIG. 8 is an enlarged view of a principal portion of FIG. 3;

FIG. 9 is an enlarged view of a principal portion of FIG. 4;

FIG. 10 is an enlarged view of a principal portion of FIG. 5;

FIGS. 11A to 11Y are spot diagrams of Example 1;

FIGS. 12A to 12Y are spot diagrams of Example 2;

FIGS. 13A to 13Y are spot diagrams of Example 3;

FIGS. 14A to 14Y are spot diagrams of Example 4;

FIGS. 15A to 15Y are spot diagrams of Example 5;

FIG. 16 is a distortion diagram of Example 1;

FIG. 17 is a distortion diagram of Example 2;

FIG. 18 is a distortion diagram of Example 3;

FIG. 19 is a distortion diagram of Example 4;

FIG. 20 is a distortion diagram of Example 5;

FIG. 21 is a side view showing the optical construction as observed when the optical path is turned on the reduction side in the first embodiment (Example 1); and

FIG. 22 is a plan view showing the optical construction as observed when the optical path is turned on the reduction side in the second to fourth embodiments (Examples 2 to 4).

### DETAILED DESCRIPTION OF PREFERRED EMBODIMENTS

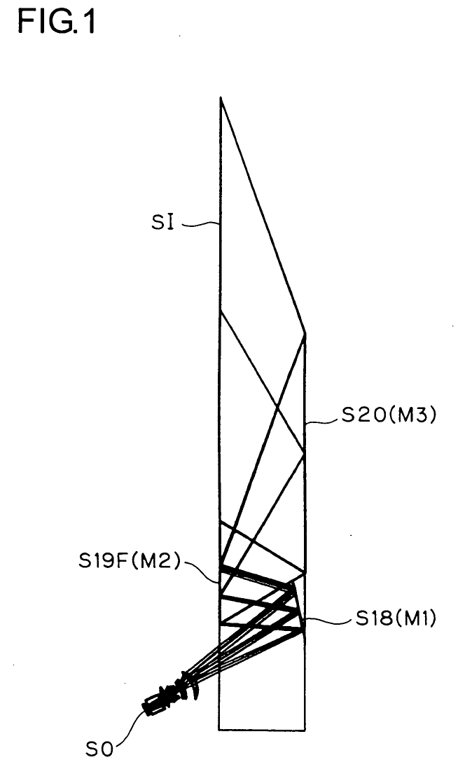

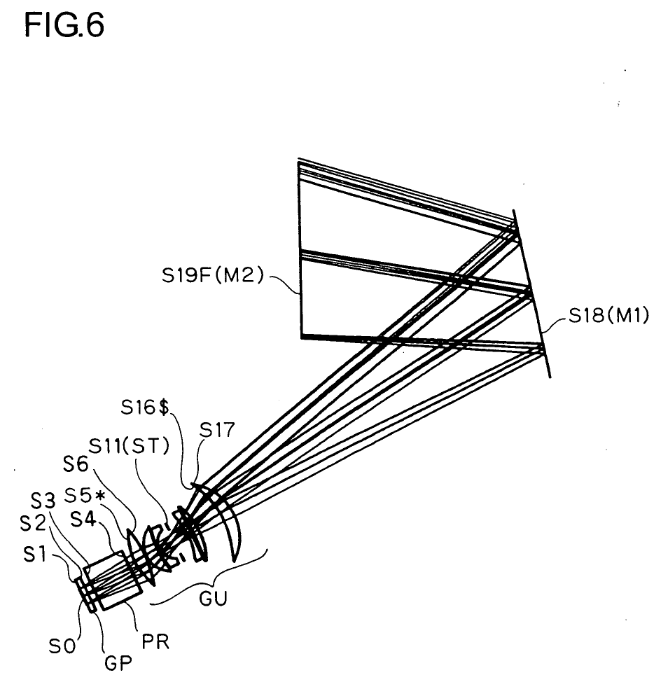

Hereinafter, projection optical systems embodying the present invention will be described with reference to the accompanying drawings. FIGS. 1 to 5 are side views of the optical construction (optical arrangement, projection optical path, and other features) along the entire projection optical path from the primary image surface SO to the secondary image surface SI in the projection optical systems of a first to fifth embodiment, respectively. FIGS. 6 to 10 are enlarged views of a principal portion of FIGS. 1 to 5, respectively. In any of these embodiments, the optical construction may be turned upside down as compared with that specifically shown in FIGS. 1 to 10; that is, the construction shown in FIGS. 1 to 10 may be inverted, without causing any problem, to suit the actual projection apparatus construction, optical system arrangement, etc. In FIGS. 1 to 10, an optical surface marked with an asterisk (*) is a rotation-symmetric aspherical surface, an optical surface marked with a dollar mark ($) is a non-rotation-symmetric aspherical surface (i.e., so-called free-form surface), and an optical surface marked with an “F” is a rotation-symmetric Fresnel aspherical surface.

The first to fifth embodiments all deal with a projection optical system that performs enlargement projection obliquely from a primary image surface SO to a secondary image surface SI. Thus, the primary image surface SO corresponds to the image formation surface (for example, image display surface) of a light valve that forms a two-dimensional image by modulating the intensity of light, and the secondary image surface SI corresponds to a projected image surface (for example, screen surface). Close to the primary image surface SO is located a glass plate GP (FIGS. 6 to 10), which is the cover glass of the light valve. In the embodiments, the light valve is assumed to be realized with a digital micromirror device. This, however, is not meant to limit the choice of the light valve in any way; it is possible to use any other non-luminous, reflective (or transmissive) display device (for example, a liquid crystal display device) that suits the oblique projection optical systems of the embodiments. In a case where the light valve is realized with a digital micromirror device, the light that falls on it is spatially modulated by being reflected by a large number of micromirrors of which each is in either an ON or OFF state (for example, inclined at either ±12°) at a time. Here, only the light reflected by micromirrors in the ON state enters the oblique projection optical system so as to be projected onto the screen surface. Incidentally, instead of the light valve, a luminous display device may be used. Using a luminous display device as an image display device eliminates the need to use a light source or the like for illumination, and thus helps to make the optical construction more lightweight and compact.

In all the embodiments, the oblique projection optical system has an optical construction suitable for a rear-projection-type image projection apparatus (rear projector). The same optical system can also be used, as an oblique projection optical system that performs reduction projection obliquely from the secondary image surface SI to the primary image surface SO, in an image reading apparatus. In that case, the primary image surface SO corresponds to the image-sensing surface of an image sensor (for example, a CCD, i.e., charge-coupled device) that reads an image, and the secondary image surface SI corresponds to the surface of the image to be read (i.e., the document surface). In those embodiments in which the reflective surface through which the optical path runs immediately before reaching the secondary image surface SI on the enlargement side is a flat reflective surface, if the flat mirror that provides the flat reflective surface is removed, and a screen is disposed at the position at which the secondary image surface SI is now located, the optical system can be used in a front-projection-type image projection apparatus (front projector). Likewise, in those embodiments in which the reflective surface through which the optical path runs immediately before reaching the secondary image surface SI on the enlargement side is a Fresnel reflective surface, if the Fresnel mirror that provides the Fresnel reflective surface is replaced with a transmissive Fresnel lens, and a screen is disposed at the position at which the secondary image surface SI is now located, the optical system can be used in a front-projection-type image projection apparatus (front projector). Even with these modifications made, the respective optical systems can be used as a reduction optical system.

The first embodiment (FIGS. 1 and 6) deals with an example of a projection optical system in which the optical path of a coaxial optical system that is obliquely telecentric on the primary image surface SO side is turned with a first and a third mirror M1 and M3, which are flat mirrors, and a second mirror M2, which is a Fresnel mirror. “Obliquely telecentric” refers to the feature that the pupil of the projection optical system as viewed from the primary image surface SO side is located sufficiently far away and in addition the center thereof is located off the line normal to the center of the primary image surface SO. In Example 1, which will be presented later as a numerical example corresponding to this embodiment, the center of the pupil is located, as measured in the local coordinate system established with respect to the primary image surface SO, at a position shifted from the center of the primary image surface SO by 20,000 mm in the vx-vector direction (in the direction parallel to the line normal to the primary image surface SO and running from the primary image surface SO to the secondary image surface SI) and by 1,000 mm in the vy-vector direction (in the direction perpendicular to the vx vector and substantially vertically upward in the figures). Hence, the principal ray that passes through a given point on the primary image surface SO side is inclined at about 2.86° relative to the line normal to the primary image surface SO. The radius of the pupil is 2,892.264 mm. Adopting an obliquely telecentric arrangement like this is advantageous in terms of mitigating the conditions that induce interference associated with the turning of the optical path. On the other hand, adopting a telecentric arrangement makes it possible to reduce the f-number on the primary image surface SO by effectively exploiting, by the use of a TIR (total internal reflection) prism or the like, the separation angle between the illumination light that illuminates the primary image surface SO and the projection light that reflects from the primary image surface SO. Thus, as compared with adopting an obliquely telecentric arrangement, adopting a telecentric arrangement is more advantageous in terms of brightness.

In addition to the above-described addition of an obliquely telecentric arrangement, in reality, a refractive lens group GU (S5 to S17) is arranged with a shift with respect to the primary image surface SO. Thus, rays pass obliquely through the entire refractive lens group GU. In this embodiment, an aperture stop ST is located only at one surface S11. To permit oblique passage of rays, it is preferable that the surface S11 be arranged with an inclination, or that an extra stopping surface is added close to the surface S11. When simulative ray tracing was performed with Example 1, which will be presented later, the optical path, spot diagrams, and distortion were calculated under the conditions that all the initial rays that pass through the obliquely telecentric pupil leave the primary image surface SO and reach the secondary image surface SI.

The rays that have left the primary image surface SO pass through the cover glass GP, located close to the primary image surface SO, and then through a prism PR. These two components have surfaces S1 to S4, which all have no optical power, and are thus not counted in the refractive lens group GU. The prism PR is for separating the illumination and projection light from each other, and is used in combination with a reflective microdevice (such as a liquid crystal display device or digital micromirror device). Thus, the prism PR may be omitted when a transmissive microdevice is used. Instead of the prism PR, a polarization-selective reflective element such as a wire grid may be used. The rays then pass through the refractive lens group GU, which have surfaces S5 to S17. Within this refractive lens group GU, the surface S5 is a rotation-symmetric aspherical surface, and the surface S16 is a non-rotation-symmetric aspherical surface. The rays that have exited from the refractive lens group GU are reflected on a flat reflective surface S18 of the first mirror M1, are then reflected on a Fresnel reflective surface S19 of the second mirror M2, are then reflected on a flat reflective surface S20 of the third mirror M3, and then reach the secondary image surface SI.

In the first embodiment, as will be understood from the optical path diagram, an optical surface at which rays pass through only about a half of the surface is given a non-rotation-symmetric shape. This makes it possible to properly correct the image surface and to correct for distortion. The same effect is exploited in the second to fourth embodiments, which will be described later. An optical surface having a non-rotation-symmetric shape like this is more difficult to produce and evaluate than a spherical or rotation-symmetric surface, which can be produced by polishing or turning. For this reason, it is preferable that such a non-rotation-symmetric surface be so shaped as to offer maximum surface accuracy and minimum susceptibility to the influence of the environment. For example, the non-rotation-symmetric lens (free-form-surface lens) having the surfaces S16 and S17 is thick enough to be produced by a production method such as injection molding using resin, which method ensures smooth flow of the resin, promising high surface accuracy. In a case where, as in the later-described second to fifth embodiments, a lens so shaped as to have nearly no optical power is used as a rotation-symmetric lens or non-rotation-symmetric lens, the lens exhibits low optical sensitivity to changes in the environment (for example, exhibits little variation in the optical power thereof in response to variation in temperature), promising high optical performance.

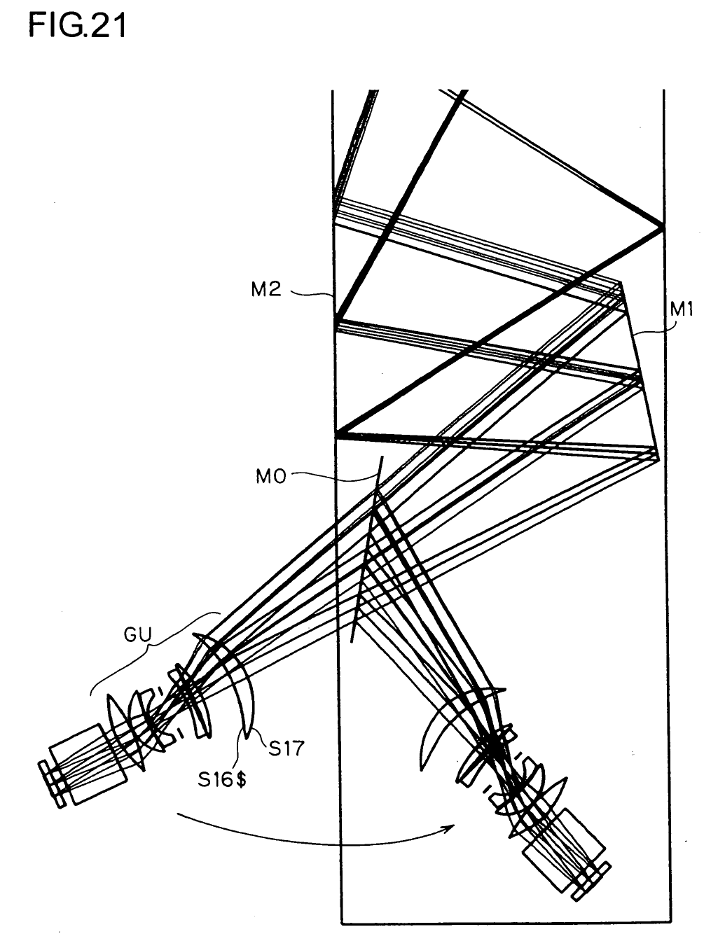

In the optical path diagram of FIG. 1, the reduction side portion of the projection optical system is located outside the contour line of the projection apparatus. This projection apparatus can be made slimmer by turning the optical path (as indicated by an arrow) with a flat mirror M0 disposed between the last surface S17 of the refractive lens group GU and the first mirror M1 (S18) as shown in FIG. 21. Although the optical path is turned within the plane of the figure (the XY-plane) in FIG. 21, it can also be turned so as to travel out of the plane of the figure, in which case the projection apparatus is made slimmer in the y-direction of the local coordinate system at the secondary image surface SI (i.e., in the direction along the shorter sides of the projected image).

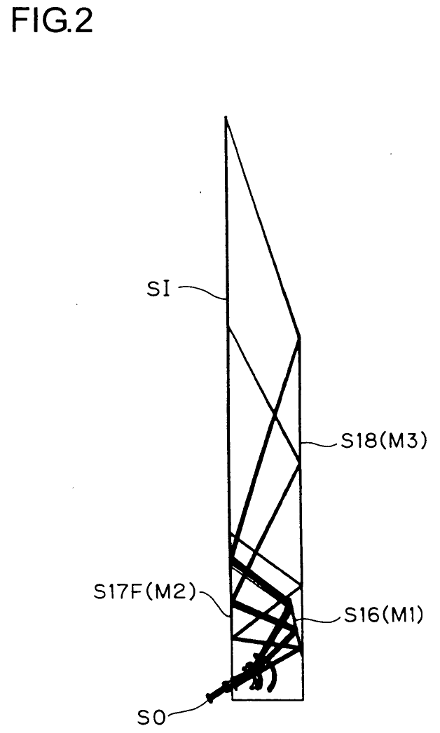

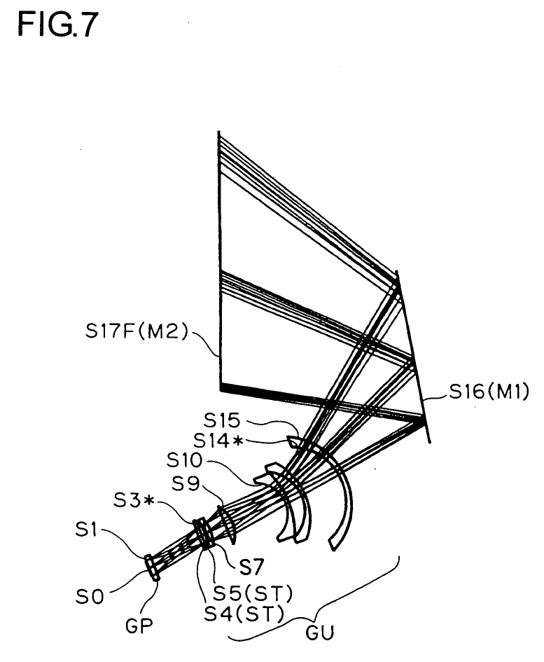

The second embodiment (FIGS. 2 and 7) deals with an example that uses a non-telecentric non-axisymmetric optical system. A non-telecentric projection optical system has the advantage of eliminating the need for a large, heavy prism even when a reflective microdevice is used; it also has the advantage of requiring no positive optical power to achieve telecentricity on the primary image surface SO side.

As in the first embodiment, the rays that have left the primary image surface SO pass through a cover glass GP located close to the primary image surface SO. The rays then pass through a refractive lens group GU composed of surfaces S3 to S15. In this refractive lens group GU, the surfaces S3 and S14 are rotation-symmetric aspherical surfaces, and the surfaces S5 to S7 constitute a cemented lens group. Aperture stops ST are located individually at the surface S4 and S5. Alternatively, one aperture stop may be located between the surfaces S4 and S5, or may be substituted by part of a lens barrel. The refractive lens group GU, composed of the surfaces S3 to S15, is coaxial as a whole, but the optical system of the second embodiment as a whole is non-coaxial. Thus, the optical axis of the refractive lens group GU is not parallel to the line normal to the primary image surface SO. This construction alleviates interference associated with the turning of the optical path, and offers good image surface flatness. The rays that have exited from the refractive lens group GU are reflected on a flat reflective surface S16 of a first mirror M1, are then reflected on a Fresnel reflective surface S17 of a second mirror M2, are then reflected on a flat reflective surface S18 of a third mirror M3, and the reach the secondary image surface SI.

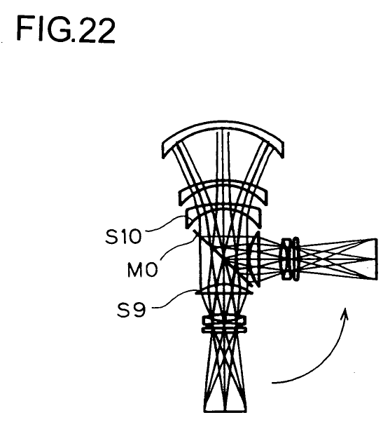

In the optical path diagram of FIG. 2, the reduction side portion of the projection optical system is located outside the contour line of the projection apparatus. This projection apparatus can be made slimmer, and also more compact in the y-direction of the local coordinate system at the secondary image surface SI (i.e., in the direction along the shorter sides of the projected image), by turning the optical path in such a way that it travels out of the plane of FIG. 7 (i.e., the XY-plane) (as indicated by an arrow in FIG. 22) with a flat mirror M0 disposed, as shown in FIG. 22, between the surfaces S9 and S10 of the refractive lens group GU shown in FIG. 7. This applies also to the third and fourth embodiments, which will be described later. Alternatively, the optical path may be turned within the plane of the figure (i.e., within the XY plane).

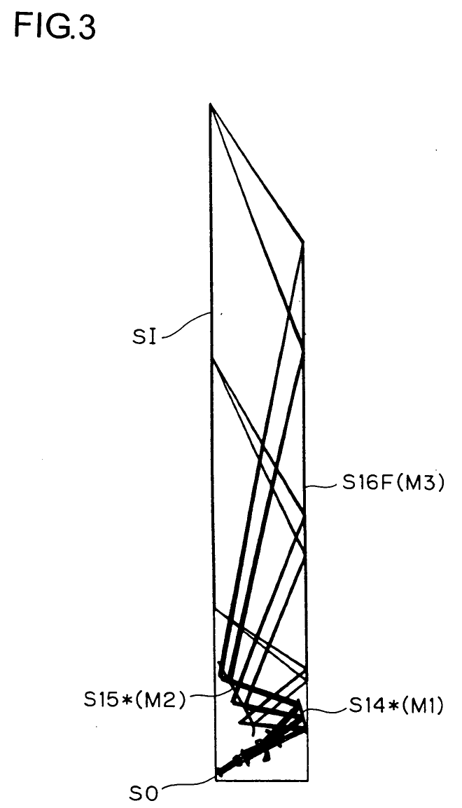

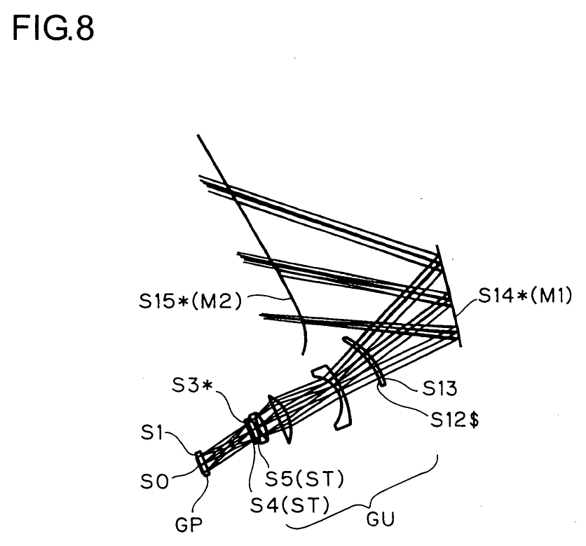

In the third embodiment (FIGS. 3 and 8), a first mirror M1 is a curved-surface mirror that has a positive optical power and that has a rotation-symmetric aspherical surface, and a second mirror M2 is a curved-surface mirror that has a negative optical power and that has a rotation-symmetric aspherical surface. Moreover, the surface through which the optical path runs immediately before reaching the secondary image surface SI is provided by a third mirror M3, which is a Fresnel mirror having a positive optical power. Thus, without the use of a single flat mirror, optical elements from the primary image surface SO to the second mirror M2 are efficiently arranged within the space sandwiched between the secondary image surface SI and the third mirror M3. This third embodiment is the only example, among all the embodiments described herein, in which the second reflective surface counted from the secondary image surface SI side is not a Fresnel reflective surface. Having the third smallest relative thickness (of which a description will be given later) among the first to fifth embodiments (Table 26), the third embodiment boasts of the smallest distortion, and has the feature that the large positive Petzval sum produced by the second mirror M2 is alleviated by the positive optical power of the first mirror M1.

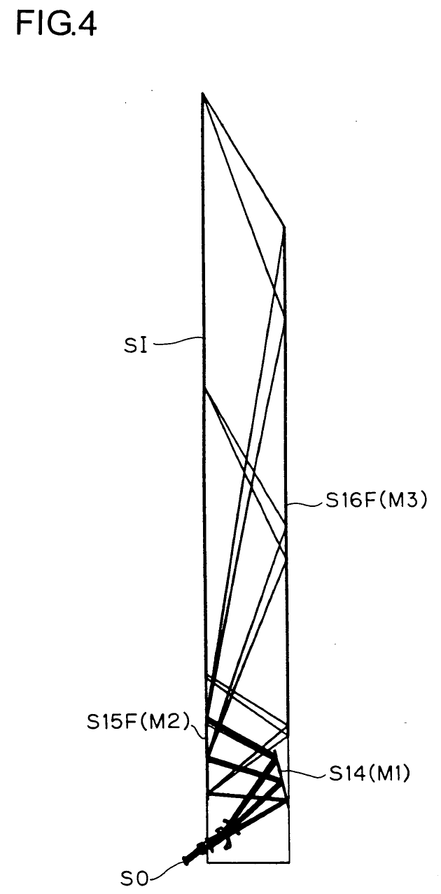

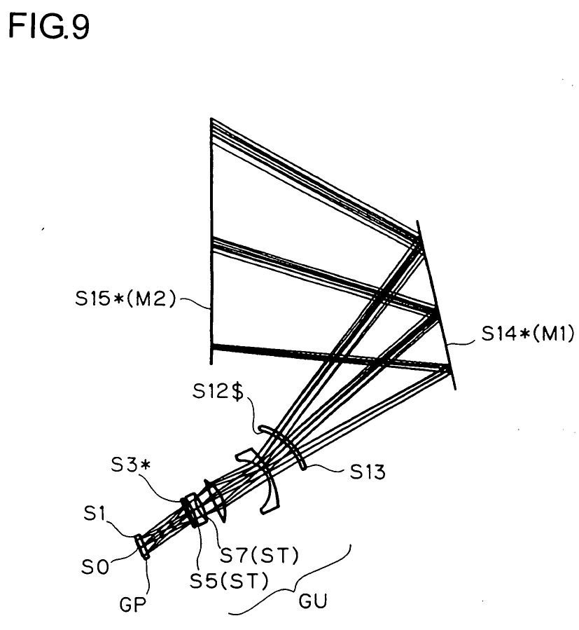

In the fourth embodiment (FIGS. 4 and 9), the first surface counted from the secondary image surface SI side is a Fresnel reflective surface having a positive optical power, and the second surface is a Fresnel reflective surface having a negative optical power. This gives the projection apparatus the smallest thickness (D/V2, of which a description will be given later) (see Table 26), and also offers good image surface flatness.

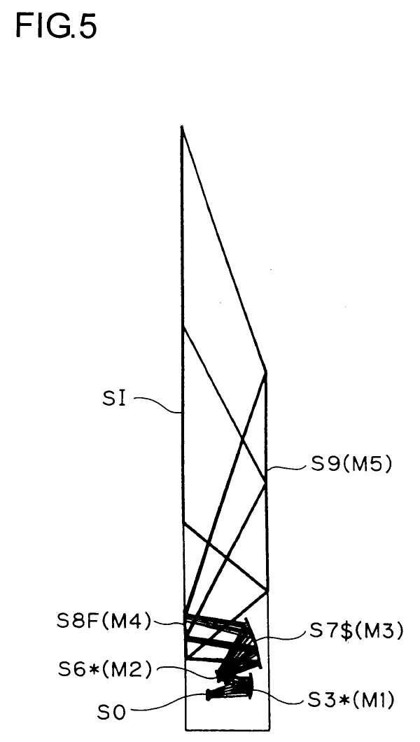

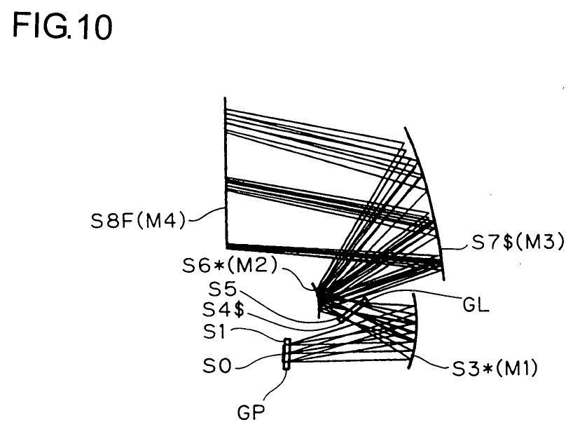

In the fifth embodiment (FIGS. 5 and 10), as in the first embodiment, an arrangement obliquely telecentric on the primary image surface SO side is adopted, and no real aperture stop is provided. In Example 5, which will be presented later as a numerical example corresponding to this embodiment, the center of the pupil is located, as measured in the local coordinate system established with respect to the primary image surface SO, at a position shifted from the center of the primary image surface SO by 100,400 mm in the vx-vector direction and by −20,000 mm in the vy-vector direction. The radius of the pupil is 14,491.492 mm. The rays that have left the primary image surface SO pass through a cover glass GP located close to the primary image surface SO, are then reflected on a rotary-symmetric aspherical reflective surface of a first mirror M1 having a positive optical power, and then pass through a non-rotation-symmetric lens GL (surfaces S4 and S5). The position of an aperture stop corresponds to the vicinity of the surfaces S3 and S4. The rays that have exited from the non-rotation-symmetric lens GL are reflected on a rotary-symmetric aspherical reflective surface S6 of a second mirror M2 having a negative optical power, are then reflected on a non-rotary-symmetric aspherical reflective surface. S7 of a third mirror M3 having a positive optical power, are then reflected on a Fresnel reflective surface S8 of a fourth mirror M4 having a negative optical power, are then reflected from a flat reflective surface S9 of a fifth mirror M5, and then reach the secondary image surface SI.

In a projection optical system for performing enlargement projection from a primary image surface SO on the reduction side to a secondary image surface SI on the enlargement side, it is preferable, as in all the embodiments, that there be disposed two or more reflective surfaces from the secondary image surface SI side, that, of the first and second reflective surfaces from the secondary image surface SI side, at least one have a negative optical power, and that there be disposed at least one Fresnel reflective surface having a positive or negative optical power within the entire optical system. Giving a negative optical power to at least one of the first and second reflective surfaces from the secondary image surface SI side makes it possible to obtain a wider angle of view. In particular, giving a negative optical power to the second reflective surface counted from the secondary image surface SI side as in all the embodiments makes it possible to effectively obtain a wider angle of view.

Moreover, using at least one Fresnel reflective surface having a positive or negative optical power within the entire optical system makes it possible to obtain good image surface flatness and thereby to obtain good quality in the projected image. With a curved-surface mirror, giving it a strong negative optical power with a view to achieving a wider angle of view and further slimness produces a large positive Petzval sum, resulting in poor image surface flatness. By contrast, with a Fresnel reflective surface, the macroscopic surface shape thereof can be made flat; that is, it can be given a strong negative optical power with no degradation in image surface flatness. Thus, it is possible to achieve a wider angle of view and further slimness while maintaining good optical performance. Moreover, a reflective optical element that provides a Fresnel reflective surface, as compared with one having a common curved-surface reflective surface, occupies less space, making it easy to prevent interference associated with the turning of the optical path, and can be made lighter and slimmer, permitting the projection apparatus as a whole to be made lighter and slimmer. Furthermore, using a Fresnel reflective surface makes it possible to simplify the designs of other optical elements, and thus makes it possible to obtain a wider angle of view without the use of a large aspherical mirror, which is difficult to produce.

Using a Fresnel reflective surface having a negative optical power rather than a curved-surface reflective surface makes it easy to turn the optical path while making the projection apparatus more compact and achieving a wider angle of view. For example, in a front projector, even when a Fresnel reflective surface having a negative optical power is used as the most secondary image surface SI side reflective surface, it is possible to make the projector slimmer and simultaneously achieve a wider angle of view. Using a Fresnel reflective surface having a negative optical power as the second reflective surface counted from the secondary image surface SI side, for example in a rear projector, makes it easy to obtain a wider angle of view, to improve image surface flatness, to prevent interference, and to achieve other improvements. Using a flat reflective surface as the third reflective surface counted from the secondary image surface SI side as in the first, second, and fourth embodiments makes easier to turn the optical path. Using a Fresnel reflective surface having a positive optical power as the first reflective surface counted from the secondary image surface SI side helps to make gentle the angles (i.e., screen incidence angles) at which rays fall on the secondary image surface SI. This makes it possible to obtain bright images with less unevenness in brightness (i.e., to obtain an improved brightness distribution and higher brightness) in both rear-projection and front-projection systems.

It is preferable, as in all the embodiments, that there be provided at least one refractive optical element, and that the refractive optical element be disposed in the optical path on the primary image surface SO side of a Fresnel reflective surface. As compared with a reflective optical element, a refractive optical element is less sensitive to errors, and is thus easier to produce and easier to adjust (for example, in terms of the position thereof relative to a holding frame). Thus, disposing a refractive optical element in the optical path on the primary image surface SO side of a Fresnel reflective surface helps to realize a highly accurate optical construction. Moreover, since the Petzval sum produced by a negative mirror is difficult to correct for with a refractive optical element, combining a Fresnel reflective surface with a refractive optical element is effective in obtaining good image surface flatness.

It is preferable that the line normal to the macroscopic surface of a Fresnel reflective surface be substantially parallel to the line normal to the secondary image surface SI. This surface arrangement has the advantage of making it easy to turn the optical path while making the projection apparatus more compact. For example, in the fourth embodiment, the surface arrangement of both the second and third mirrors M2 and M3 fulfills the above requirement, effectively achieving slimness.

In all the embodiments, a Fresnel reflective surface is arranged with the line normal thereto substantially parallel to the line normal to the secondary image surface SI, and its macroscopic surface is formed into a flat surface. This makes it possible to use the available space efficiently. Inclining the line normal to a Fresnel reflective surface by several degrees or more from its state in the respective embodiments, or forming the macroscopic surface of the Fresnel reflective surface into a curved surface, makes it possible to effectively alleviate the vignetting resulting from the shape of the Fresnel reflective surface. In a case where a Fresnel surface, lenticular lens, or the like for condensing or diverging light is disposed near the screen, the moiré produced thereby needs to be taken into consideration in designing the pitch of the Fresnel shape. For example, when a Fresnel reflective surface is used as the first surface counted from the secondary image surface SI, it is preferable that the Fresnel reflective surface be given a pitch about 1/50 to ½ of the value calculated by multiplying the pixel pitch of the microdevice located on the primary image surface SO by the projection magnification β. In a case where a Fresnel reflective surface is used as the second surface counted from the secondary image surface SI, it is preferable that the Fresnel reflective surface be given a pitch about 1/100 to ¼ of the just-mentioned value.

To reduce the stray light produced by the diffraction that takes place on a Fresnel reflective surface, it is preferable that the Fresnel reflective surface be given a pitch about 10 times or more, or 1/10 or less of, the wavelength of the light that is passed through the projection optical system. To prevent a contiguous part of an image from being deflected to a position far away from the ideal point, it is preferable that the Fresnel reflective surface be given a pitch twice or less the diameter with which the light beam coming from one point on the primary image surface SO falls on the Fresnel reflective surface. In a case where a Fresnel reflective surface is used that has a pitch equal to the diameter with which the light beam coming from one point on the primary image surface SO falls on the Fresnel reflective surface, about one line per pixel appears as an image on average. It is, however, preferable that the Fresnel reflective surface be given a pitch finer than that, because then the projected image appears more natural. Light beams coming from different points on the primary image surface SO fall on a Fresnel reflective surface with different diameters, and therefore, with consideration given to the differences in beam width among different light beams falling on the Fresnel reflective surface, it is preferable to use a Fresnel reflective surface having a non-uniform pitch.

The reflective optical element (Fresnel mirror) that is used to provide a Fresnel reflective surface in the respective embodiments is obtained by coating with a reflective coating (such as a metal thin film) an optical component produced by injection molding, stamping, cutting, or the like. Examples of the material of such optical components include plastic (such as UV-hardening resin), glass, and metal.

According to the present invention, a projection optical system includes, somewhere within the entire system thereof, at least one Fresnel reflective surface having a positive or negative optical power. This helps to obtain good image surface flatness and thereby to obtain good quality in the projected image. Moreover, interference associated with the turning of the optical path can easily be prevented. This helps to realize a projection apparatus that is lightweight and slim as a whole. Moreover, of the first and second reflective surfaces counted from the secondary image surface side, at least one is a reflective surface having a negative optical power. This makes it possible to obtain a wider angle of view. In this way, it is possible to realize a projection optical system that, despite offering good optical performance, is advantageous in terms of mass production and cost reduction, is slim, and is composed of lightweight, compact optical components.

### EXAMPLES

Hereinafter, practical examples of projection optical systems embodying the present invention will be presented with references to their construction data and other data. Examples 1 to 5 presented below are numerical examples corresponding to the first to fifth embodiments, respectively, described above, and therefore the optical construction diagrams (FIGS. 1 to 10) showing the respective embodiments also show the optical construction, projection optical path, and other features of the corresponding examples.

Tables 1 to 24 show the optical construction of Examples 1 to 5. Of these tables, Tables 1 and 2, Tables 6 and 7, Tables 10 and 11, Tables 15 and 16, and Tables 20 and 21 show, for Examples 1 to 5, respectively, the optical arrangement throughout the entire optical system including the primary image surface (SO, corresponding to the object surface in enlargement projection) on the reduction side to the secondary image surface (SI, corresponding to the image surface in enlargement projection) on the enlargement side in the form of construction data. In the construction data (part 1 of 2) of each example, Sn (n=1, 2, 3, . . . ) represents the n-th surface counted from the reduction side, with the radius of curvature of the surface represented by CR (mm) and the axial distance from that surface to the next one on the enlargement side thereof represented by T (mm). The refractive index to the d-line and the Abbe number of the medium are represented by Nd and vd, respectively. Incidentally, the refractive optical element that provides the surfaces S1 and S2 is the cover glass that covers the primary image surface SO, and, for an aperture stop ST, the aperture radius thereof is shown together.

In all the examples, the global coordinate system (X, Y, Z) has the origin (Go) thereof located at the center of the primary image surface SO, and any coordinate vector therein are defined by unit vectors VX (1, 0, 0), VY (0, 1, 0), and VZ (0, 0, 1) that are perpendicular to one another. Thus, in the construction data (part 2 of 2) of each example, the origin (o) of the primary image surface SO coincides with the origin (Go) of the global coordinate system. Incidentally, the vector VX is a unit vector that is parallel to the line normal to the primary image surface SO and that, starting at the origin (Go), is directed from the primary image surface SO to the consecutive surface located on the secondary image surface SI side thereof, the vector VY is a unit vector that is perpendicular to the vector VX and that, starting at the origin (Go), is directed toward the secondary image surface SI in the direction along the shorter sides of the primary image surface SO; the vector VZ is defined, on a right hand system basis, as a unit vector that starts at the origin (Go) and that is perpendicular to both the vectors VX and VY.

The global coordinates at the vertex of each surface are as shown in the construction data (part 2 of 2) of each example. In a coaxial part (block) of the optical system, the global coordinates are found on the basis of the axial distance T. Specifically, assume that a particular surface within the coaxial block is a surface SLi, that the most primary image surface SO side surface of the block to which the surface SLi belongs is a surface SL, that the vertex of the surface SL is a point Lo, and that the vx vector (unit vector) of the surface SL be a vector Lovx; then, the vertex of the surface SLi is located at the position Li displaced from the point Lo in the direction of the vector Lovx over a distance equal to the sum of the axial distances T that accompany the surfaces within the block up to the one immediately before the surface SLi. Thus, the local vectors with respect to the surface SLi are obtained by moving the three mutually perpendicular unit vectors with respect to the surface SLi in such a way that they start at the point Li.

For example, in the case of Example 2, the surfaces S16, S17, and S18 and the secondary image surface SI do not belong to a coaxial block, and therefore their respective representations by global coordinates are exactly the same as those found in the construction data (part 2 of 2). The surfaces S1 and S2 belong to a coaxial block consisting of the surfaces from S0 to S2, and therefore, with the surface SO assumed to be the surface SL, the vertex of the surface SI is expressed as a point (0.5, 0, 0) displaced from the point Lo=(0, 0, 0) in the direction of the vector Lovx=(1, 0, 0) over an axial distance T=0.5 mm, and the vertex of the surface S2 is expressed as a point (3.5, 0, 0) displaced from the point Lo in the direction of the vector Lovx over a distance of 3.5 mm (0.5 mm+3 mm). Moreover, the rectangular coordinate vectors are vx=(1, 0, 0), vy=(0, 1, 0), and vz=(0, 0, 1). The surfaces S4 to S15 belong to a coaxial block consisting of the surfaces from S3 to S15, and therefore, with the surface S3 assumed to be the surface SL, the vertices of those surfaces are calculated by similar procedures.

For Examples 1 to 4, in which the coaxial part occupies a large part of the optical system, the surfaces are represented in terms of axial distances T. By contrast, for Example 5, in which the coaxial part occupies a small part of the optical system, all the surfaces are expressed in terms of their respective vertices and vector data. In the construction data (part 1 of 2), the radius of curvature CR of each surface is given a sign determined with respect to the x-axis of the local rectangular coordinate system, a positive sign indicating that the center of the curvature is located in the positive direction along the local vx vector. For a Fresnel reflective surface, however, the radius of curvature CR represents the radius of curvature of the macroscopic shape thereof.

In the construction data (part 1 of 2), a surface marked with an asterisk (*) is a rotation-symmetric aspherical surface, of which the surface shape is defined by formula (AS) below using the rectangular coordinate system (x, y, z) having the origin at the vertex of the surface. A surface marked with a dollar mark ($) is a non-rotation-symmetric extended aspherical surface, of which the surface shape is defined by formula (BS) below using the rectangular coordinate system (x, y, z) having the origin at the vertex of the surface. A surface marked with a letter “F” is a rotation-symmetric Fresnel reflective surface, of which the surface shape is defined by formula (FS) below using the rectangular coordinate system (x, y, z) having the origin at the vertex of the surface. Tables 3 to 5, Tables 8 and 9, Tables 12 to 14, Tables 17 to 19, and Tables 22 to 24 show the rotation-symmetric aspherical surface data, extended aspherical surface data, and Fresnel aspherical data of Examples 1 to 5, respectively. It should be noted that the coefficient of any unlisted term equals zero, and that, for all the data, “E−n” stands for “×10⁻ⁿ” and “E+n” stands for “×10⁺ⁿ.”
x=(C0−h²)/(1+\sqrt{1−ε·C0²·h²})+Σ(Ai−hⁱ) (AS)
x=(C0·h²)/(1+\sqrt{1−ε·C0²·h²})+Σ(Bjk·y^{j}·z^{k}) (BS)
R(h)=Σ(Fm·h^{m}) (FS)
where
x represents the displacement from the reference surface in the x-axis direction as measured at the height h (relative to the vertex);
h represents the height in a direction perpendicular to the x-axis (h²=y²+z²);
C0 represents the curvature at the vertex (with the sign determined with respect to the x-axis, the positive sign indicating that the center of the curvature lies in the positive direction along the vector vx);
ε represents the quadric surface parameter;
Ai represents the aspherical coefficient of i-th order;
Bjk represents the extended aspherical coefficient of j-th order with respect to y and k-th order with respect to z;
Fm represents the Fresnel aspherical coefficient of m-th order; and
R(h) represents the radius of curvature at the height h. (Assume that the vector parallel to the Fresnel rotation center axis is a vector Rvx, that the radius about the vector Rvx is a height h, that the surface (not necessarily flat) defined by using the vector Rvx as the x-direction vector of the local rectangular coordinate system is a macroscopic surface Sf, and that the point on the surface Sf that intersects the height h is a point P. Then, the surface shape of a Fresnel reflective surface at the point P follows the sphere that has the center on the Rvx vector and that passes through the point P. The sign of R(h) is so determined that, as seen from the point at which the plane including the point P and perpendicular to the vector Rvx intersects the rotation center axis, if the center of R(h) is located in the direction of the vector Rvx, R(h) is positive. Incidentally, the surface Sf is the surface that represents the macroscopic shape of a Fresnel reflective surface, and the surface Sf is flat in all the embodiments.)

Table 25 shows the image size (mm) on the primary image surface SO and the projection magnification. The image on the primary image surface SO is rectangular, with the ±Y-direction of the primary image surface SO aligned with the direction of the shorter sides of the image and the ±Z-direction of the primary image surface SO aligned with the direction of the longer sides of the image. The projection magnification is calculated through paraxial tracing performed by using as the “central principal rays” the rays that pass through the center of the primary image surface SO and the center of the aperture stop ST. Specifically, βy is the absolute value of the projection magnification calculated through paraxial tracing on the xy-section, βz is the absolute value of the projection magnification in the direction perpendicular to βy, and P is the mean (=(βy+βz)/2) of βy and βz.

Table 26 shows the data V2 and D related to the thickness of the projection apparatus. V2 (mm)=the width of the secondary image surface SI in the direction of the shorter sides thereof=β times the width (4.9248 mm×2) of the primary image surface SO in the direction of the shorter sides thereof. D (mm)=the thickness of the projection apparatus in the direction of the line normal to the secondary image surface SI. The thickness of the projection apparatus can be expressed by the use of these two values V2 and D. The smaller the ratio of D to V2 (D/V2), the slimmer the projection apparatus. In Examples 1, 2, and 4, as shown in their respective optical path diagrams (FIGS. 1, 2, and 4), the primary image surface SO protrudes in the thickness direction. For Example 1, the given values are those observed when the optical path is turned within the XY-plane between the refractive lens group GU and the Fresnel reflective surface (FIG. 21); for Examples 2 and 4, the given values are those observed when the optical path is turned in the middle of the refractive lens group GU so as to travel out of the XY-plane (i.e., out of the plane of the figure) (FIG. 22). In all the examples, the thickness of the projection apparatus is determined by two surfaces, namely the secondary image surface SI and the first reflective surface along the optical path from the secondary image surface SI to the primary image surface SO.

Table 27 shows the incidence angles (°) of the principal rays (i.e., the rays that travel from given points on the primary image surface SO through the center of the aperture stop ST to the secondary image surface SI) with respect to the secondary image surface SI. In Example 5, in which no real aperture stop is provided, the rays that pass through the center of the pupil are assumed to be the principal rays. For each example, the incidence angle data at 25 points (with the maximum incidence angle indicated by a triangular symbol “Δ”) are given, which points largely correspond to spot barycenter positions, which will be described later. In a case where a rear projection apparatus is built with a projection optical system, using a Fresnel mirror as the first reflective surface counted from the secondary image surface SI has the effect of making gentle the angles at which rays fall on the secondary image surface SI. This effect is clearly observed in the data shown in Table 27. Specifically, the table shows the following: in Examples 3 and 4, the thickness of the projection apparatus is smaller than in Examples 1 and 5; in Example 4, the thickness is even smaller than in Example 2, but the maximum incidence angle on the secondary image surface SI is small.

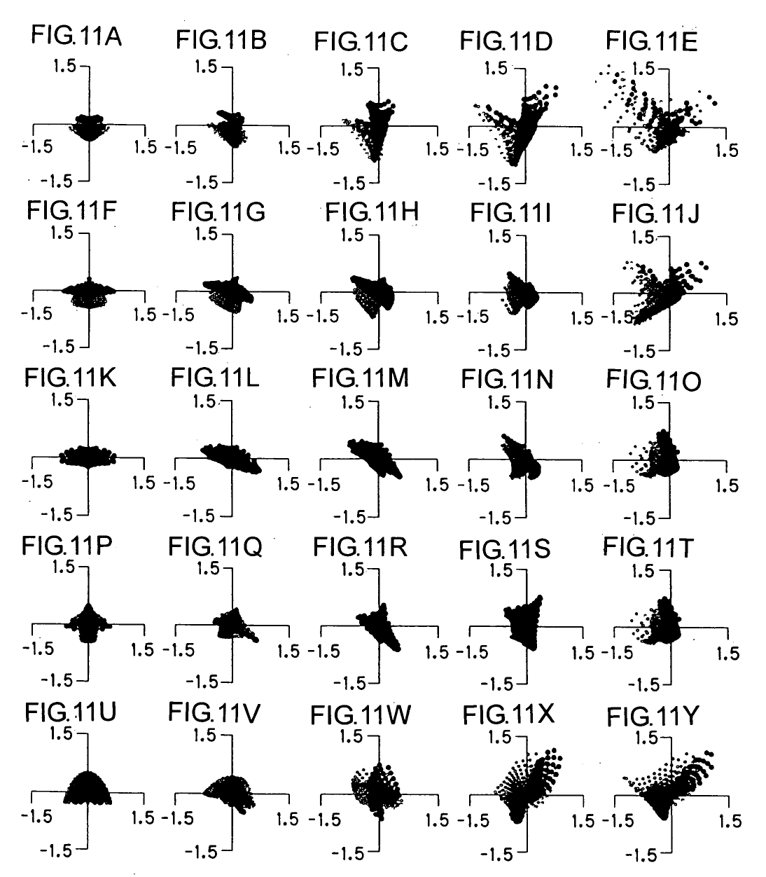

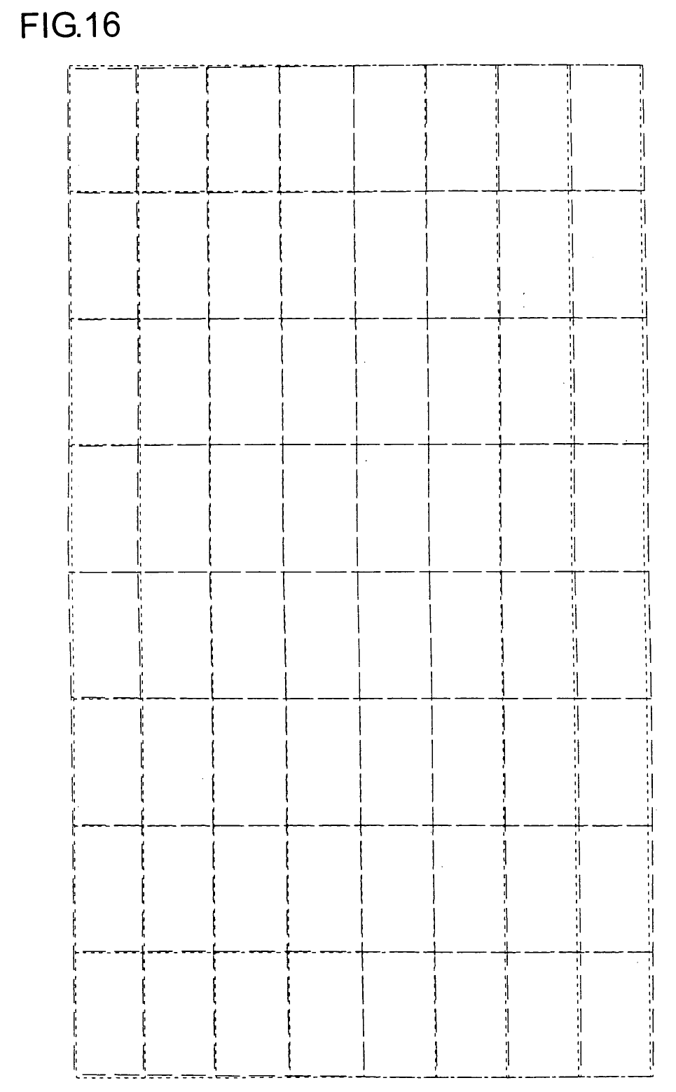

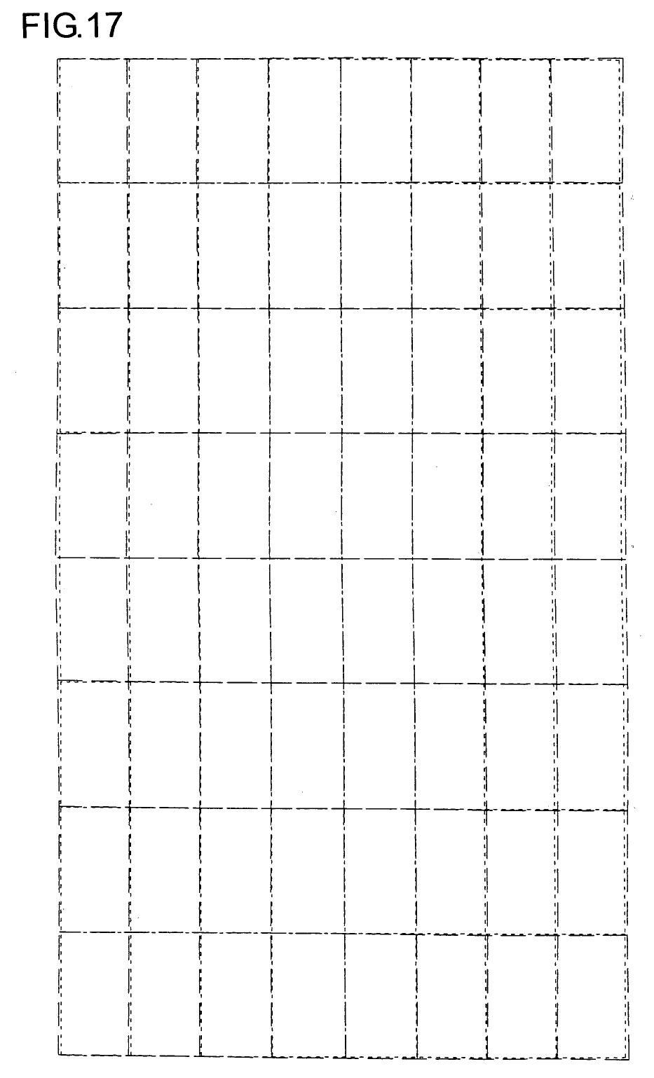

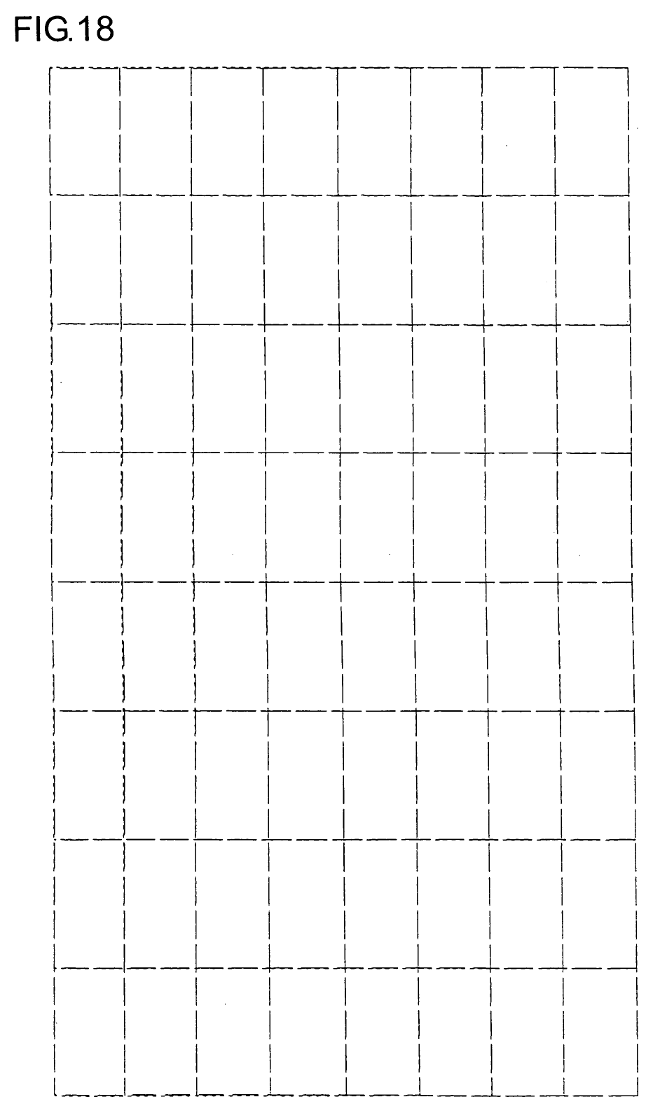

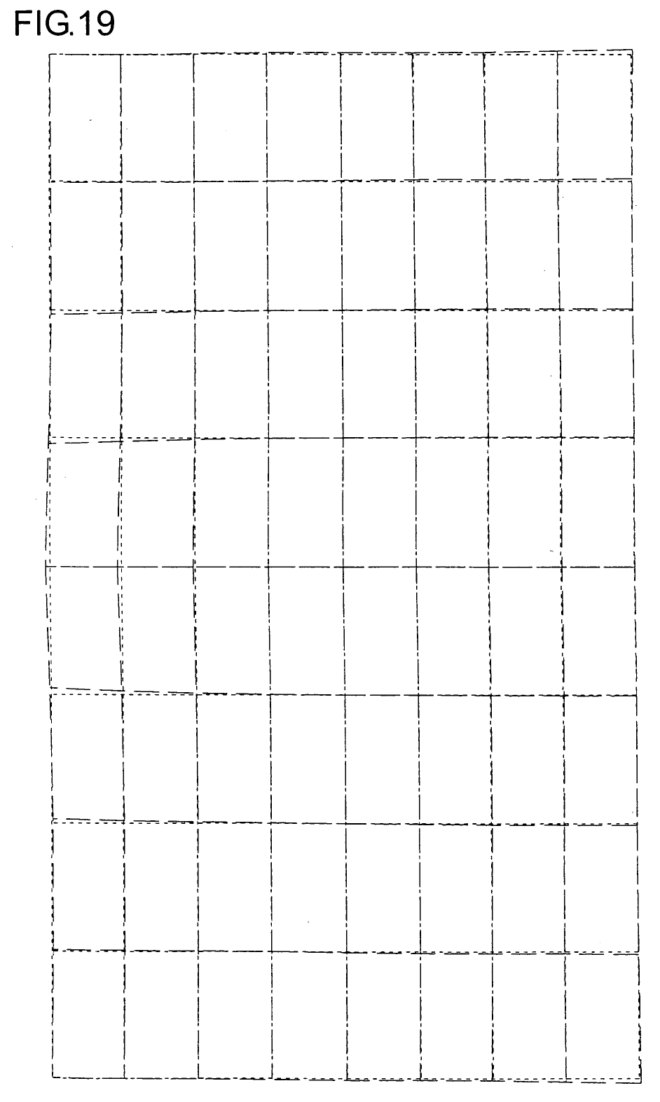

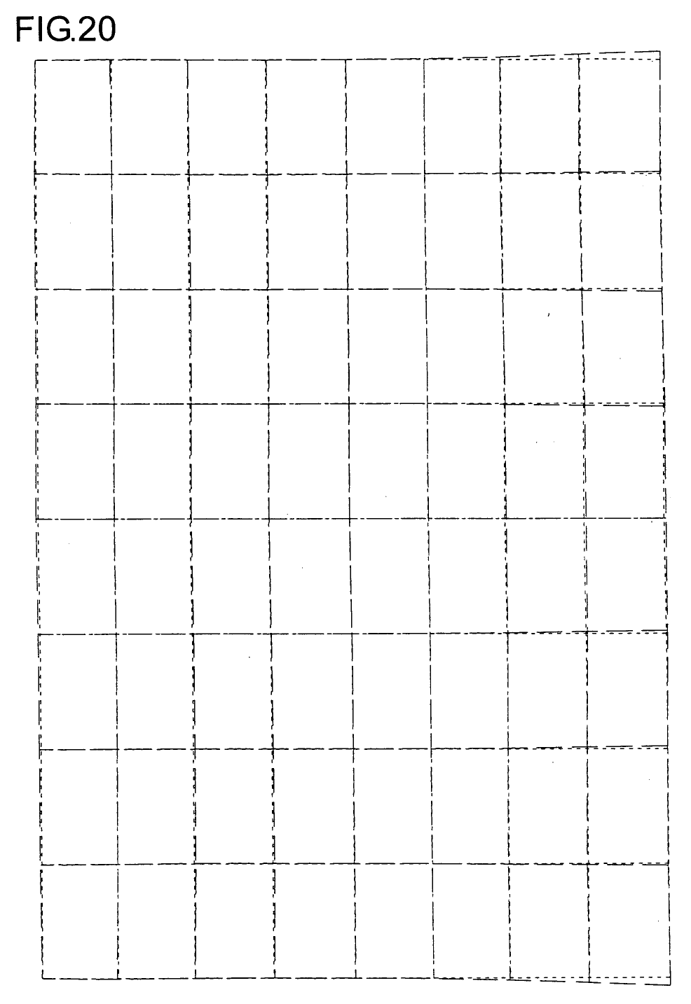

The optical performance of Examples 1 to 5 is shown in spot diagrams (FIGS. 11A-11Y to FIGS. 15A-15Y) and distortion diagrams (FIGS. 16 to 20), respectively. In each spot diagram, the imaging performance (on a ±1.5 mm scale) on the secondary image surface SI is shown as observed at three wavelengths (450 nm, 546 nm, and 630 μm) and at 25 evaluation points (“A” to “Y” corresponding to the suffixes of the figure numbers of the relevant spot diagrams). Tables 28 to 32 show the projected spot barycenter positions of the individual evaluation points (“A” to “Y”) as expressed by coordinates in the local coordinate system (y, z, in mm) established with respect to the secondary image surface SI. In all the examples, the optical system is plane-symmetric about the XY-plane, and therefore the spot diagrams show only the z-direction positive-side half of the data observed on the secondary image surface SI, with the other half omitted.

Each distortion diagram shows the ray positions (in mm, at a wavelength of 546 nm) on the secondary image surface SI which correspond to a rectangular grid on the primary image surface SO. Specifically, on the primary image surface SO, nine equally spaced imaginary lines are drawn along the shorter sides thereof and nine equally spaced imaginary lines are drawn along the longer sides thereof. The 81 intersection points between these lines are projected onto the secondary image surface SI, and the deviations of the barycenters from the ideal projection positions are connected together with long-stroke broken lines to obtain a distortion grid, which is shown in each distortion diagram. Short-stroke broken lines indicate the ideal projection positions (without distortion) of the respective points, i.e., the positions occupied in the local coordinate system (y, z) with respect to the secondary image surface SI by the values calculated by multiplying by the projection magnifications βy and βz the original coordinates in the local coordinate system (y, z) with respect to the primary image surface SO. The distortion diagrams show the entire area of the secondary image surface SI, with no omission of one half of the image.

TABLE 1

Construction Data (Part 1 of 2)

| | |
|---|---|
| Example 1 | Aperture |

| Surface | CR[mm] | T[mm] | Nd | νd | Radius |
|---|---|---|---|---|---|
| SO | ∞ | 0.5 | 1.000000 | | |
| S1 | ∞ | 3.000 | 1.508470 | 61.1900 | (GP) |
| S2 | ∞ | 4.000 | 1.000000 | | |
| S3 | ∞ | 24.000 | 1.516800 | 64.2000 | (PR) |
| S4 | ∞ | | 1.000000 | | |
| S5* | 28.408 | 7.232 | 1.743300 | 49.3000 | |
| S6 | −64.862 | 0.300 | 1.000000 | | |
| S7 | 16.086 | 7.407 | 1.784846 | 48.9867 | |
| S8 | 61.060 | 0.299 | 1.000000 | | |
| S9 | 43.191 | 0.987 | 1.805180 | 25.4600 | |
| S10 | 9.904 | 9.701 | 1.000000 | | |
| S11 | ∞(ST) | 8.598 | 1.000000 | | 5.29 |
| S12 | −41.930 | 2.000 | 1.805180 | 25.4600 | |
| S13 | −6590.059 | 1.270 | 1.000000 | | |
| S14 | −113.336 | 3.535 | 1.810000 | 47.0000 | |
| S15 | −40.314 | 15.190 | 1.000000 | | |
| S16$ | −54.146 | 7.025 | 1.809842 | 45.7394 | |
| S17 | −31.001 | | 1.000000 | | |
| S18 | ∞(M1) | | 1.000000 | | |
| S19F | ∞(M2) | | 1.000000 | | |
| S20 | ∞(M3) | | 1.000000 | | |
| SI | ∞ | | | | |

TABLE 2

| Example 1 | | | | |
|---|---|---|---|---|
| | Position/ | Construction Data (Part 2 of 2) | | |
| Surface | Vector | X | Y | Z |
| SO | o | 0.000 | 0.000 | 0.000 |
| | vx | 1.000 | 0.000 | 0.000 |
| | vy | 0.000 | 1.000 | 0.000 |
| | vz | 0.000 | 0.000 | 1.000 |
| S5 | o | 35.493 | 6.205 | 0.000 |
| | vx | 0.9999 | −0.0120 | 0.0000 |
| | vy | 0.0120 | 0.9999 | 0.0000 |
| | vz | 0.0000 | 0.0000 | 1.0000 |
| S18 | o | 307.519 | 45.737 | 0.000 |
| (M1) | vx | 0.971 | −0.237 | 0.000 |
| | vy | 0.237 | 0.971 | 0.000 |
| | vz | 0.000 | 0.000 | 1.000 |
| S19 | o | 166.904 | 55.674 | 0.000 |
| (M2) | vx | −0.904 | 0.427 | 0.000 |
| | vy | 0.427 | 0.904 | 0.000 |
| | vz | 0.000 | 0.000 | −1.000 |
| S20 | o | 432.246 | 286.192 | 0.000 |
| (M3) | vx | 0.904 | −0.427 | 0.000 |
| | vy | 0.427 | 0.904 | 0.000 |
| | vz | 0.000 | 0.000 | 1.000 |
| SI | o | 409.853 | 570.225 | 0.000 |
| | vx | −0.904 | 0.427 | 0.000 |
| | vy | −0.427 | −0.904 | 0.000 |
| | vz | 0.000 | 0.000 | 1.000 |

TABLE 3

| | |
|---|---|
| | Rotation-Symmetric Aspherical |
| Example 1 | Surface Data of Surface S5: Ai |

| ε | A4 | A6 | A8 | A10 |
|---|---|---|---|---|
| 1.0 | −1.57410E−05 | −3.63103E−09 | 5.84547E−12 | −1.34024E−14 |

TABLE 4

| | |
|---|---|
| Example 1 | Extended Aspherical Surface Data of Surface S16: Bjk |

| | j = 0 | j = 1 | j = 2 | j = 3 | j = 4 |
|---|---|---|---|---|---|
| k = 0 | | | −8.23841E−04 | −5.84443E−06 | −3.39849E−08 |
| k = 2 | −8.81874E−04 | 7.73975E−06 | −1.46028E−06 | 8.55241E−08 | −1.46508E−09 |
| k = 4 | 3.62390E−07 | −5.77757E−08 | 4.50203E−09 | −1.74584E−10 | 5.26870E−12 |
| k = 6 | −7.23023E−10 | 5.18309E−11 | 3.59958E−13 | | |
| k = 8 | 7.91763E−13 | | | | |
| | j = 5 | j = 6 | j = 7 | j = 8 | |
| k = 0 | −1.17023E−08 | 1.94287E−09 | −9.69843E−11 | 2.00145E−12 | |
| k = 2 | −9.07445E−11 | 4.80673E−12 | | | |

TABLE 5

| | |
|---|---|
| Example 1 | Fresnel Aspherical Surface Data of Surface S19: Fm |

| F0 | F2 | F4 | F6 | F8 | F10 |
|---|---|---|---|---|---|
| 9.80798E+01 | 1.70582E−02 | −6.97490E−07 | 3.09361E−11 | −7.47448E−16 | 7.32108E−21 |

TABLE 6

Construction Data (Part 1 of 2)

| | |
|---|---|
| Example 2 | Aperture |

| Surface | CR[mm] | T[mm] | Nd | νd | Radius |
|---|---|---|---|---|---|
| SO | ∞ | 0.5 | 1.000000 | | |
| S1 | ∞ | 3.000 | 1.508470 | 61.1900 | (GP) |
| S2 | ∞ | | 1.000000 | | |
| S3* | 56.856 | 1.998 | 1.682993 | 48.0237 | |
| S4 | ∞(ST) | 2.046 | 1.000000 | | 5.72 |
| S5 | −59.045(ST) | 0.800 | 1.805180 | 25.4600 | 5.39 |
| S6 | 18.721 | 2.904 | 1.598488 | 60.6506 | |
| S7 | −27.453 | 8.818 | 1.000000 | | |
| S8 | 1905.211 | 4.063 | 1.585325 | 39.3951 | |
| S9 | −18.912 | 31.783 | 1.000000 | | |
| S10 | −17.637 | 2.000 | 1.564273 | 62.9818 | |
| S11 | −49.479 | 8.382 | 1.000000 | | |
| S12 | −22.436 | 2.000 | 1.729160 | 54.6700 | |
| S13 | −34.852 | 20.804 | 1.000000 | | |
| S14* | −32.000 | 2.967 | 1.525100 | 56.3800 | |
| S15 | −39.085 | | 1.000000 | | |
| S16 | ∞(M1) | | 1.000000 | | |
| S17F | ∞(M2) | | 1.000000 | | |
| S18 | ∞(M3) | | 1.000000 | | |
| SI | ∞ | | | | |

TABLE 7

| Example 2 | | | | |
|---|---|---|---|---|
| | Position/ | Construction Data (Part 2 of 2) | | |
| Surface | Vector | X | Y | Z |
| SO | o | 0.000 | 0.000 | 0.000 |
| | vx | 1.000 | 0.000 | 0.000 |
| | vy | 0.000 | 1.000 | 0.000 |
| | vz | 0.000 | 0.000 | 1.000 |
| S3 | o | 33.200 | 7.873 | 0.000 |
| | vx | 1.0000 | −0.0014 | 0.0000 |
| | vy | 0.0014 | 1.0000 | 0.0000 |
| | vz | 0.0000 | 0.0000 | 1.0000 |
| S16 | o | 185.268 | 54.979 | 0.000 |
| (M1) | vx | 0.983 | −0.183 | 0.000 |
| | vy | 0.183 | 0.983 | 0.000 |
| | vz | 0.000 | 0.000 | 1.000 |
| S17 | o | 65.789 | 48.940 | 0.000 |
| (M2) | vx | −0.927 | 0.375 | 0.000 |
| | vy | 0.375 | 0.927 | 0.000 |
| | vz | 0.000 | 0.000 | −1.000 |
| S18 | o | 183.404 | 24.972 | 0.000 |
| (M3) | vx | 0.923 | −0.385 | 0.000 |
| | vy | 0.385 | 0.923 | 0.000 |
| | vz | 0.000 | 0.000 | 1.000 |
| SI | o | 284.277 | 578.100 | 0.000 |
| | vx | −0.923 | 0.385 | 0.000 |
| | vy | −0.385 | −0.923 | 0.000 |
| | vz | 0.000 | 0.000 | 1.000 |

TABLE 8

| | |
|---|---|
| | Rotation-Symmetric Aspherical |
| Example 2 | Surface Data of Surface S3: Ai |

| ε | A4 | A6 | A8 | A10 |
|---|---|---|---|---|
| 1.0 | −4.52803E−05 | 5.23182E−09 | −3.86372E−09 | 4.23798E−11 |

| | |
|---|---|
| | Rotation-Symmetric Aspherical |
| Example 2 | Surface Data of Surface S14: Ai |

| ε | A4 | A6 | A8 | A10 |
|---|---|---|---|---|
| 1.0 | 7.74634E−07 | −1.04461E−08 | 1.65347E−11 | −1.26472E−14 |

TABLE 9

| | |
|---|---|
| Example 2 | Fresnel Aspherical Surface Data of Surface S17: Fm |

| F0 | F2 | F4 | F6 | F8 | F10 |
|---|---|---|---|---|---|
| 1.15567E+02 | 1.99042E−02 | −3.44208E−07 | 1.01217E−11 | −1.43217E−16 | 7.47037E−22 |

TABLE 10

Construction Data (Part 1 of 2)

| | |
|---|---|
| Example 3 | Aperture |

| Surface | CR[mm] | T[mm] | Nd | νd | Radius |
|---|---|---|---|---|---|
| SO | ∞ | 0.5 | 1.000000 | | |
| S1 | ∞ | 3.000 | 1.508470 | 61.1900 | (GP) |
| S2 | ∞ | | 1.000000 | | |
| S3* | 109.056 | 1.600 | 1.743633 | 49.2406 | |
| S4 | ∞(ST) | 2.932 | 1.000000 | | 5.06 |
| S5 | −27.719(ST) | 1.063 | 1.805152 | 25.4608 | 5.53 |
| S6 | 17.018 | 3.820 | 1.741873 | 53.1798 | |
| S7 | −24.461 | 8.922 | 1.000000 | | |
| S8 | −558.446 | 5.770 | 1.688707 | 30.3457 | |
| S9 | −22.085 | 31.572 | 1.000000 | | |
| S10 | −17.141 | 2.478 | 1.728258 | 33.6009 | |
| S11 | −54.350 | 21.878 | 1.000000 | | |
| S12$ | −43.747 | 2.500 | 1.525100 | 56.3800 | |
| S13 | −43.944 | | 1.000000 | | |
| S14* | −203.780(M1) | | 1.000000 | | |
| S15* | 24.827(M2) | | 1.000000 | | |
| S16F | ∞(M3) | | 1.000000 | | |
| SI | ∞ | | | | |

TABLE 11

| Example 3 | | | | |
|---|---|---|---|---|
| | Position/ | Construction Data (Part 2 of 2) | | |
| Surface | Vector | X | Y | Z |
| SO | o | 0.000 | 0.000 | 0.000 |
| | vx | 1.000 | 0.000 | 0.000 |
| | vy | 0.000 | 1.000 | 0.000 |
| | vz | 0.000 | 0.000 | 1.000 |
| S3 | o | 33.200 | 7.209 | 0.000 |
| | vx | 0.9999 | 0.0137 | 0.0000 |
| | vy | −0.0137 | 0.9999 | 0.0000 |
| | vz | 0.0000 | 0.0000 | 1.0000 |
| S14 | o | 163.217 | 5.514 | 0.000 |
| (M1) | vx | 0.974 | −0.228 | 0.000 |
| | vy | 0.228 | 0.974 | 0.000 |
| | vz | 0.000 | 0.000 | 1.000 |
| S15 | o | 82.713 | 43.964 | 0.000 |
| (M2) | vx | −0.917 | 0.399 | 0.000 |
| | vy | 0.399 | 0.917 | 0.000 |
| | vz | 0.000 | 0.000 | −1.000 |
| S16 | o | 168.304 | 15.317 | 0.000 |
| (M3) | vx | 0.929 | −0.369 | 0.000 |
| | vy | 0.369 | 0.929 | 0.000 |
| | vz | 0.000 | 0.000 | 1.000 |
| SI | o | 262.126 | 673.262 | 0.000 |
| | vx | −0.929 | 0.369 | 0.000 |
| | vy | −0.369 | −0.929 | 0.000 |
| | vz | 0.000 | 0.000 | 1.000 |

TABLE 12

| | |
|---|---|
| | Rotation-Symmetric Aspherical |
| Example 3 | Surface Data of Surface S3: Ai |

| ε | A4 | A6 | A8 | A10 |
|---|---|---|---|---|
| 1.0 | −4.65669E−05 | −3.64469E−08 | −4.49893E−09 | 7.51820E−11 |

| | |
|---|---|
| | Rotation-Symmetric Aspherical |
| Example 3 | Surface Data of Surface S14: Ai |

| ε | A4 | A6 | A8 | A10 |
|---|---|---|---|---|
| 1.00000 | 7.34077E−07 | −1.71135E−10 | 2.15616E−14 | −1.08802E−18 |

| | |
|---|---|
| | Rotation-Symmetric Aspherical |
| Example 3 | Surface Data of Surface S15: Ai |

| ε | A4 | A6 | A8 | A10 |
|---|---|---|---|---|
| −2.23777 | −7.55482E−08 | 7.96494E−12 | −3.83154E−16 | 7.05266E−21 |

TABLE 13

| | |
|---|---|
| Example 3 | Extended Aspherical Surface Data of Surface S12: Bjk |

| | j = 0 | j = 1 | j = 2 | j = 3 | j = 4 |
|---|---|---|---|---|---|
| k = 0 | | | −2.38449E−03 | 8.19810E−05 | 4.52236E−08 |
| k = 2 | −2.08520E−03 | 1.05994E−04 | −1.12165E−06 | −3.25916E−07 | 4.66143E−08 |
| k = 4 | 3.59809E−06 | −4.93832E−07 | 3.87587E−08 | −8.30059E−10 | −1.64562E−10 |
| k = 6 | −6.29913E−09 | 1.03761E−09 | −8.78094E−11 | 4.33233E−12 | −8.22780E−14 |
| k = 8 | 6.99762E−12 | −7.26799E−13 | 3.44254E−14 | | |
| k = 10 | −1.18952E−15 | | | | |
| | j = 5 | j = 6 | j = 7 | j = 8 | j = 9 |
| k = 0 | −2.13930E−07 | 2.49952E−08 | −8.39850E−10 | −3.14143E−11 | 2.25592E−12 |
| k = 2 | −4.90163E−10 | −2.45292E−10 | 1.36036E−11 | −2.02199E−13 | |
| k = 4 | 1.23385E−11 | −2.22452E−13 | | | |
| | j = 10 | | | | |
| k = 0 | −3.12344E−14 | | | | |

TABLE 14

| | |
|---|---|
| Example 3 | Fresnel Aspherical Surface Data of Surface S16: Fm |

| F0 | F2 | F4 | F6 | F8 |
|---|---|---|---|---|
| −1.62783E+04 | 2.07620E−02 | −1.73961E−08 | 7.99460E−15 | −1.38110E−21 |

TABLE 15

Construction Data (Part 1 of 2)

| | |
|---|---|
| Example 4 | Aperture |

| Surface | CR[mm] | T[mm] | Nd | νd | Radius |
|---|---|---|---|---|---|
| SO | ∞ | 0.5 | 1.000000 | | |
| S1 | ∞ | 3.000 | 1.508470 | 61.1900 | (GP) |
| S2 | ∞ | | 1.000000 | | |
| S3* | 62.444 | 1.600 | 1.753505 | 45.5093 | |
| S4 | ∞ | 2.420 | 1.000000 | | |
| S5 | −42.008(ST) | 2.783 | 1.805172 | 25.4602 | 5.37 |
| S6 | 17.552 | 3.095 | 1.687723 | 56.1993 | |
| S7 | −33.885(ST) | 6.971 | 1.000000 | | 6.43 |
| S8 | 174.205 | 5.382 | 1.627387 | 34.8452 | |
| S9 | −20.836 | 29.047 | 1.000000 | | |
| S10 | −15.887 | 2.156 | 1.810000 | 47.0000 | |
| S11 | −46.372 | 17.822 | 1.000000 | | |
| S12$ | −33.000 | 2.500 | 1.525100 | 56.3800 | |
| S13 | −35.000 | | 1.000000 | | |
| S14 | ∞(M1) | | 1.000000 | | |
| S15F | ∞(M2) | | 1.000000 | | |
| S16F | ∞(M3) | | 1.000000 | | |
| SI | ∞ | | | | |

TABLE 16

| Example 4 | | | | |
|---|---|---|---|---|
| | Position/ | Construction Data (Part 2 of 2) | | |
| Surface | Vector | X | Y | Z |
| SO | o | 0.000 | 0.000 | 0.000 |
| | vx | 1.000 | 0.000 | 0.000 |
| | vy | 0.000 | 1.000 | 0.000 |
| | vz | 0.000 | 0.000 | 1.000 |
| S3 | o | 33.200 | 6.936 | 0.000 |
| | vx | 1.000 | −0.004 | 0.000 |
| | vy | 0.004 | 1.000 | 0.000 |
| | vz | 0.000 | 0.000 | 1.000 |
| S14 | o | 211.368 | 50.104 | 0.000 |
| (M1) | vx | 0.976 | −0.217 | 0.000 |
| | vy | 0.217 | 0.976 | 0.000 |
| | vz | 0.000 | 0.000 | 1.000 |
| S15 | o | 74.488 | 61.209 | 0.000 |
| (M2) | vx | −0.905 | 0.425 | 0.000 |
| | vy | 0.425 | 0.905 | 0.000 |
| | vz | 0.000 | 0.000 | −1.000 |
| S16 | o | 227.946 | 60.176 | 0.000 |
| (M3) | vx | 0.903 | −0.430 | 0.000 |
| | vy | 0.430 | 0.903 | 0.000 |
| | vz | 0.000 | 0.000 | 1.000 |
| SI | o | 388.364 | 721.995 | 0.000 |
| | vx | −0.903 | 0.430 | 0.000 |
| | vy | −0.430 | −0.903 | 0.000 |
| | vz | 0.000 | 0.000 | 1.000 |

TABLE 17

| | |
|---|---|
| | Rotation-Symmetric Aspherical |
| Example 4 | Surface Data of Surface S3: Ai |

| ε | A4 | A6 | A8 | A10 |
|---|---|---|---|---|
| 1.0 | −4.22682E−05 | −8.46661E−08 | −1.15134E−09 | 1.00489E−11 |

TABLE 18

| | |
|---|---|
| Example 4 | Extended Aspherical Surface Data of Surface S12: Bjk |

| | j = 0 | j = 1 | j = 2 | j = 3 | j = 4 |
|---|---|---|---|---|---|
| k = 0 | | | −1.03696E−04 | 2.24591E−05 | 1.72453E−06 |
| k = 2 | −1.00634E−04 | 3.81872E−05 | −2.36242E−06 | −1.04256E−06 | 3.71720E−08 |
| k = 4 | −6.12360E−07 | −3.57752E−07 | −8.66499E−09 | 6.57245E−09 | −3.73048E−10 |
| k = 6 | −7.54656E−09 | 1.39313E−09 | −4.82394E−11 | −9.53226E−12 | 4.94989E−13 |
| k = 8 | 1.22697E−11 | −2.02988E−12 | 1.68555E−13 | | |
| k = 10 | −2.87226E−15 | | | | |
| | j = 5 | j = 6 | j = 7 | j = 8 | j = 9 |
| k = 0 | −6.75203E−07 | 1.38874E−08 | 1.47933E−09 | −5.21179E−11 | −1.28124E−12 |
| k = 2 | 3.22658E−09 | −1.61572E−10 | −3.41870E−12 | 2.09397E−13 | |
| k = 4 | −1.53801E−13 | 2.90331E−13 | | | |
| | j = 10 | | | | |
| k = 0 | 5.70201E−14 | | | | |

TABLE 19

| | |
|---|---|
| Example 4 | Fresnel Aspherical Surface Data of Surface S15: Fm |

| F0 | F2 | F4 | F6 | F8 | F10 |
|---|---|---|---|---|---|
| 9.19713E+01 | 1.73769E−02 | −5.03877E−07 | 1.68002E−11 | −3.06498E−16 | 2.22958E−21 |

| | |
|---|---|
| Example 4 | Fresnel Aspherical Surface Data of Surface S16: Fm |

| F0 | F2 | F4 | F6 | F8 | F10 |
|---|---|---|---|---|---|
| −1.50645E+04 | 1.20752E−02 | −9.06458E−09 | 2.90352E−15 | 5.89497E−22 | −2.97775E−28 |

TABLE 20

| | |
|---|---|
| Example 5 | Construction Data (Part 1 of 2) |

| Surface | CR[mm] | Nd | νd |
|---|---|---|---|
| SO | ∞ | 1.000000 | |
| S1 | ∞ | 1.5168 | 64.2(GP) |
| S2 | ∞ | 1.000000 | |
| S3* | −77.005825(M1) | 1.000000 | |
| S4$ | ∞ | 1.522 | 52.2(GL) |
| S5 | ∞ | 1.000000 | |
| S6* | 55.262002(M2) | 1.000000 | |
| S7$ | ∞(M3) | 1.000000 | |
| S8F | ∞(M4) | 1.000000 | |
| S9 | ∞(M5) | 1.000000 | |
| SI | ∞ | | |

TABLE 21

Example 5

| | Position/ | Construction Data (Part 2 of 2) | | |
|---|---|---|---|---|
| Surface | Vector | X | Y | Z |
| SO | o | 0.000 | 0.000 | 0.000 |
| | vx | 1.000 | 0.000 | 0.000 |
| | vy | 0.000 | 1.000 | 0.000 |
| | vz | 0.000 | 0.000 | 1.000 |
| S1 | o | 0.470 | 0.000 | 0.000 |
| | vx | 1.000 | 0.000 | 0.000 |
| | vy | 0.000 | 1.000 | 0.000 |
| | vz | 0.000 | 0.000 | 1.000 |
| S2 | o | 3.470 | 0.000 | 0.000 |
| | vx | 1.000 | 0.000 | 0.000 |
| | vy | 0.000 | 1.000 | 0.000 |
| | vz | 0.000 | 0.000 | 1.000 |
| S3 | o | 73.625 | −34.410 | 0.000 |
| (M1) | vx | 0.977 | −0.213 | 0.000 |
| | vy | 0.213 | 0.977 | 0.000 |
| | vz | 0.000 | 0.000 | 1.000 |
| S4 | o | 39.292 | −24.887 | 0.000 |
| | vx | −0.650 | −0.760 | 0.000 |
| | vy | −0.760 | 0.650 | 0.000 |
| | vz | 0.000 | 0.000 | −1.000 |
| S5 | o | 34.932 | −24.884 | 0.000 |
| | vx | −0.636 | −0.771 | 0.000 |
| | vy | −0.771 | 0.636 | 0.000 |
| | vz | 0.000 | 0.000 | −1.000 |
| S6 | o | 19.408 | −23.867 | 0.000 |
| (M2) | vx | −1.000 | 0.015 | 0.000 |
| | vy | 0.015 | 1.000 | 0.000 |
| | vz | 0.000 | 0.000 | −1.000 |
| S7 | o | 85.271 | −75.120 | 0.000 |
| (M3) | vx | 0.979 | −0.206 | 0.000 |
| | vy | 0.206 | 0.979 | 0.000 |
| | vz | 0.000 | 0.000 | 1.000 |
| S8 | o | −33.068 | −30.534 | 0.000 |
| (M4) | vx | −0.999 | 0.033 | 0.000 |
| | vy | 0.033 | 0.999 | 0.000 |
| | vz | 0.000 | 0.000 | −1.000 |
| S9 | o | 103.533 | −463.261 | 0.000 |
| (M5) | vx | 1.000 | 0.000 | 0.000 |
| | vy | 0.000 | 1.000 | 0.000 |
| | vz | 0.000 | 0.000 | 1.000 |
| SI | o | −36.467 | −637.193 | 0.000 |
| | vx | −1.000 | 0.000 | 0.000 |
| | vy | 0.000 | −1.000 | 0.000 |
| | vz | 0.000 | 0.000 | 1.000 |

TABLE 22

| | |
|---|---|
| | Rotation-Symmetric Aspherical |
| Example 5 | Surface Data of Surface S3: Ai |

| ε | A4 | A6 | A8 | A10 |
|---|---|---|---|---|
| 1.0 | 1.41919E−07 | −5.15936E−11 | 2.94537E−14 | −5.11089E−18 |

| | |
|---|---|
| | Rotation-Symmetric Aspherical |
| Example 5 | Surface Data of Surface S6: Ai |

| ε | A4 | A6 | A8 | A10 | A12 |
|---|---|---|---|---|---|
| 1.0 | 1.41286E−05 | −5.85372E−08 | 5.05759E−10 | −1.58056E−12 | 1.83073E−15 |

TABLE 23

| | |
|---|---|
| Example 5 | Extended Aspherical Surface Data of Surface S4: Bjk |

| | j = 0 | j = 1 | j = 2 | j = 3 | j = 4 |
|---|---|---|---|---|---|
| k = 0 | | | | 8.17012E−06 | 1.75766E−06 |
| k = 2 | | 2.19539E−05 | 5.28128E−06 | 1.03558E−06 | 6.37793E−08 |
| k = 4 | 3.48828E−06 | 1.10502E−06 | 1.01710E−07 | −3.16965E−08 | −5.66527E−09 |
| k = 6 | 9.64607E−08 | −1.72710E−08 | −2.15480E−09 | 4.11291E−10 | 2.28649E−11 |
| k = 8 | −1.47179E−09 | | | | |
| | j = 5 | j = 6 | j = 7 | j = 8 | |
| k = 0 | 9.60988E−07 | 6.08846E−08 | −1.08233E−08 | −9.51235E−10 | |
| k = 2 | −1.15718E−08 | −1.10683E−09 | | | |
| k = 4 | −5.93993E−10 | −2.95294E−11 | | | |

| | |
|---|---|
| Example 5 | Extended Aspherical Surface Data of Surface S7: Bjk |

| | j = 0 | j = 1 | j = 2 | j = 3 | j = 4 |
|---|---|---|---|---|---|
| k = 0 | | | −1.61674E−03 | 4.29862E−06 | −3.98876E−08 |
| k = 2 | −1.51329E−03 | 8.77699E−06 | 1.12458E−07 | 4.57782E−09 | 4.60716E−11 |
| k = 4 | −2.58264E−08 | −1.16993E−09 | −7.29150E−11 | −1.82699E−12 | −1.29269E−14 |
| k = 6 | 1.40874E−11 | 6.67933E−13 | 2.28648E−14 | 3.80133E−16 | 2.63011E−18 |
| k = 8 | −6.21581E−15 | −1.35959E−16 | −1.88691E−18 | | |
| k = 10 | 7.48292E−19 | | | | |
| | j = 5 | j = 6 | j = 7 | j = 8 | j = 9 |
| k = 0 | 1.16233E−09 | 7.29281E−11 | 9.80355E−13 | −2.07428E−14 | −8.10098E−16 |
| k = 2 | −1.37338E−12 | −2.23189E−14 | 3.04069E−16 | 5.14863E−18 | |
| k = 4 | 6.57537E−17 | 9.04308E−19 | | | |
| | j = 10 | | | | |
| k = 0 | −6.80707E−18 | | | | |

TABLE 24

| | |
|---|---|
| Example 5 | Fresnel Aspherical Surface Data of Surface S8: Fm |

| F0 | F2 | F4 | F6 | F8 |
|---|---|---|---|---|
| 9.39785E+01 | 5.84006E−03 | 9.69402E−03 | −4.42418E−11 | 1.41516E−15 |

TABLE 25

| | | | | Primary Image | |
|---|---|---|---|---|---|
| | | | | Size (mm) | |
| | | | | Y-Direction | Z-Direction |
| | | | | (Along Shorter | (Along Longer |
| | βy | βz | β | Sides) | Sides) |
| Example 1 | 73.179 | 73.478 | 73.329 | ±4.9248 | ±8.7552 |
| Example 2 | 71.555 | 72.555 | 72.555 | | |
| Example 3 | 88.303 | 88.303 | 88.303 | | |
| Example 4 | 101.329 | 100.846 | 101.087 | | |
| Example 5 | 68.890 | 57.537 | 63.214 | | |

TABLE 26

| | V2(mm) | D(mm) | D/V2 |
|---|---|---|---|
| Example 1 | 720.782 | 141.520 | 0.196 |
| Example 2 | 704.787 | 119.683 | 0.170 |
| Example 3 | 869.746 | 155.754 | 0.179 |
| Example 4 | 998.054 | 139.925 | 0.140 |
| Example 5 | 678.537 | 140.000 | 0.206 |

TABLE 27

| | |
|---|---|
| | Principal Ray Incidence Angle (°) |
| Example 1 | With Respect To Secondary Image Surface |

| | | | | |
|---|---|---|---|---|
| 70.79 | 71.05 | 71.76 | 72.77 | 73.93Δ |
| 66.54 | 67.01 | 68.28 | 69.99 | 71.79 |
| 60.22 | 61.15 | 63.49 | 66.4 | 69.24 |
| 49.94 | 52.19 | 57.12 | 62.2 | 66.51 |
| 31.9 | 38.44 | 49.49 | 58.13 | 64.17 |

| | |
|---|---|
| | Principal Ray Incidence Angle (°) |
| Example 2 | With Respect To Secondary Image Surface |

| | | | | |
|---|---|---|---|---|
| 72.58 | 72.8 | 73.41 | 74.28 | 75.34Δ |
| 68.97 | 69.38 | 70.47 | 71.94 | 73.47 |
| 63.47 | 64.29 | 66.34 | 68.89 | 71.36 |
| 54.32 | 56.33 | 60.73 | 65.24 | 69.04 |
| 37.16 | 43.31 | 53.67 | 61.61 | 67.03 |

| | |
|---|---|
| | Principal Ray Incidence Angle (°) |
| Example 3 | With Respect To Secondary Image Surface |

| | | | | |
|---|---|---|---|---|
| 69.52Δ | 69.35 | 68.6 | 66.34 | 60.05 |
| 69.21 | 69.39 | 69.75 | 69.78 | 68.37 |
| 65.71 | 66.35 | 67.82 | 69.25 | 69.86 |
| 57.84 | 59.84 | 63.79 | 67.24 | 69.37 |
| 39.63 | 47.68 | 58.31 | 64.85 | 68.47 |

| | |
|---|---|
| | Principal Ray Incidence Angle (°) |
| Example 4 | With Respect To Secondary Image Surface |

| | | | | |
|---|---|---|---|---|
| 69.96Δ | 69.86 | 69.42 | 68.09 | 63.51 |
| 69.13 | 69.34 | 69.77 | 69.9 | 69.01 |
| 64.95 | 65.69 | 67.39 | 69.03 | 69.73 |
| 55.7 | 58.08 | 62.72 | 66.65 | 69.02 |
| 35.15 | 43.96 | 56.36 | 63.95 | 67.93 |

| | |
|---|---|
| | Principal Ray Incidence Angle (°) |
| Example 5 | With Respect To Secondary Image Surface |

| | | | | |
|---|---|---|---|---|
| 71.7 | 71.85 | 72.26 | 72.89 | 73.65Δ |
| 68.01 | 68.26 | 68.96 | 70 | 71.26 |
| 62.75 | 63.23 | 64.53 | 66.31 | 68.31 |
| 54.31 | 55.43 | 58.22 | 61.63 | 64.94 |
| 40.2 | 43.04 | 49.43 | 56.1 | 61.62 |

TABLE 28

| | |
|---|---|
| Example 1 | Projected Spot Barycenter Positions (FIG. 11) |

| | | | | | | | | | | | | | | |
|---|---|---|---|---|---|---|---|---|---|---|---|---|---|---|
| A | y | 365.743 | B | y | 365.719 | C | y | 365.46 | D | y | 364.574 | E | y | 363.294 |
| | z | 8.62868E−19 | | z | 161.305 | | z | 322.411 | | z | 482.907 | | z | 642.576 |
| F | y | 181.449 | G | y | 181.575 | H | y | 182.058 | I | y | 182.793 | J | y | 182.876 |
| | z | 4.74577E−18 | | z | 160.869 | | z | 321.823 | | z | 482.924 | | z | 643.509 |
| K | y | −0.138883 | L | y | −0.385346 | M | y | −0.87184 | N | y | −0.790466 | O | y | 0.220077 |
| | z | −8.62868E−19 | | z | 160.734 | | z | 321.069 | | z | 481.363 | | z | 642.43 |
| P | y | −181.831 | Q | y | −181.559 | R | y | −181.617 | S | y | −182.319 | T | y | 0.220077 |
| | z | 1.72574E−18 | | z | 160.689 | | z | 321.242 | | z | 480.678 | | z | 642.43 |
| U | y | −365.973 | V | y | −364.798 | W | y | −363.133 | X | y | −362.979 | Y | y | −363.22 |
| | z | 1.00668E−18 | | z | 158.722 | | z | 320.145 | | z | 480.445 | | z | 638.958 |

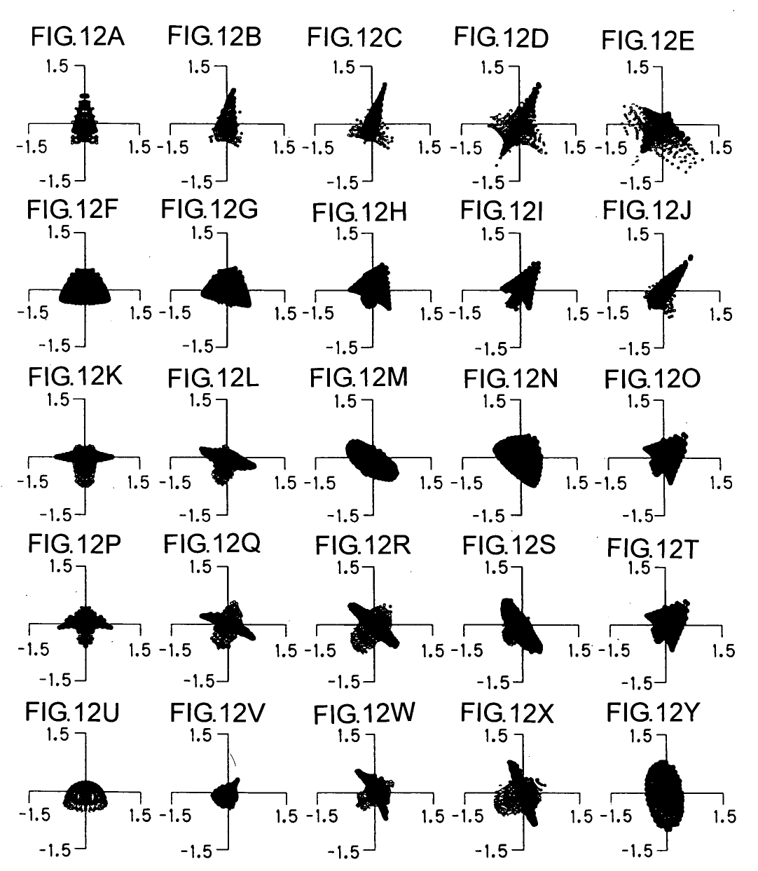

TABLE 29

| | |
|---|---|
| Example 2 | Projected Spot Barycenter Positions (FIG. 12) |

| | | | | | | | | | | | | | | |
|---|---|---|---|---|---|---|---|---|---|---|---|---|---|---|
| A | y | 359.109 | B | y | 358.915 | C | y | 358.118 | D | y | 356.799 | E | y | 358.007 |
| | z | 2.52945E−18 | | z | 159.169 | | z | 318.115 | | z | 476.6 | | z | 636.459 |
| F | y | 178.376 | G | y | 178.576 | H | y | 179.146 | I | y | 179.514 | J | y | 178.265 |
| | z | −5.30006E−18 | | z | 158.737 | | z | 317.819 | | z | 477.156 | | z | 635.455 |
| K | y | −0.253213 | L | y | −0.443385 | M | y | −0.783835 | N | y | −0.580701 | O | y | 0.0582867 |
| | z | −5.57901E−19 | | z | 158.363 | | z | 316.721 | | z | 475.638 | | z | 635.464 |
| P | y | −178.181 | Q | y | −177.902 | R | y | −178.007 | S | y | −178.922 | T | y | 0.0582867 |
| | z | 1.99271E−18 | | z | 158.224 | | z | 316.757 | | z | 474.833 | | z | 635.464 |
| U | y | −359.08 | V | y | −357.808 | W | y | −356.095 | X | y | −356.343 | Y | y | −357.368 |
| | z | 6.47151E−19 | | z | 156.189 | | z | 315.778 | | z | 474.98 | | z | 632.817 |

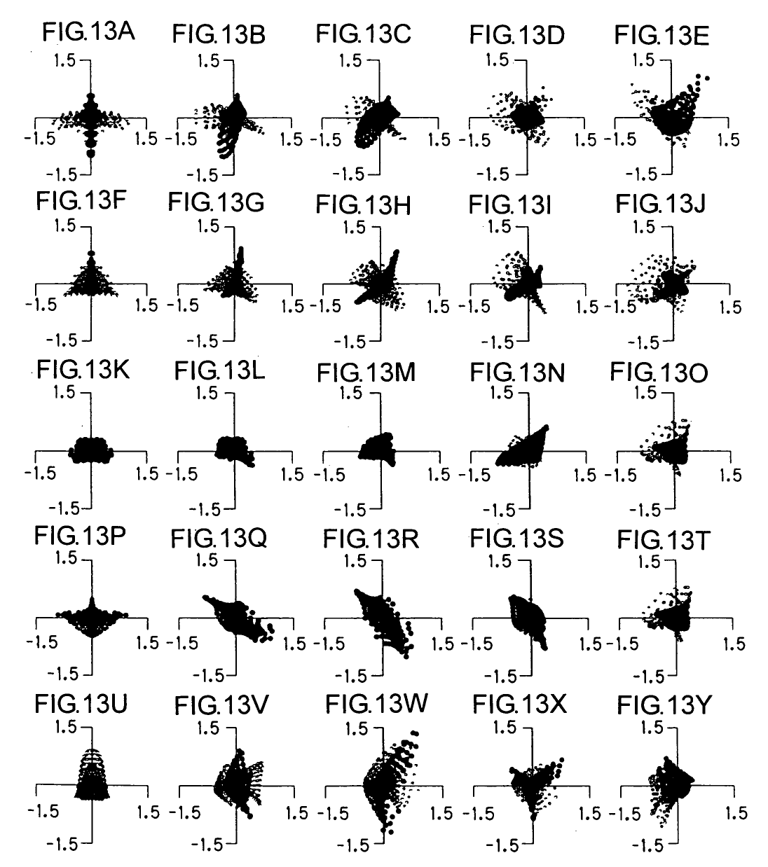

TABLE 30

| | |
|---|---|
| Example 3 | Projected Spot Barycenter Positions (FIG. 13) |

| | | | | | | | | | | | | | | |
|---|---|---|---|---|---|---|---|---|---|---|---|---|---|---|
| A | y | 433.133 | B | y | 433.252 | C | y | 433.42 | D | y | 433.169 | E | y | 433.274 |
| | z | −3.41817E−20 | | z | 193.708 | | z | 387.467 | | z | 581.429 | | z | 776.141 |
| F | y | 217.011 | G | y | 216.9 | H | y | 216.677 | I | y | 216.983 | J | y | 217.622 |
| | z | −2.09213E−19 | | z | 193.772 | | z | 387.29 | | z | 581.145 | | z | 776.081 |
| K | y | −0.10926 | L | y | −0.11635 | M | y | −0.0377509 | N | y | −0.138658 | O | y | 0.0746162 |
| | z | −1.81318E−18 | | z | 193.985 | | z | 387.753 | | z | 581.09 | | z | 774.859 |
| P | y | −215.604 | Q | y | −215.893 | R | y | −216.726 | S | y | −217.019 | T | y | 0.0746162 |
| | z | −2.84673E−19 | | z | 194.425 | | z | 387.933 | | z | 581.222 | | z | 774.859 |
| U | y | −433.597 | V | y | −432.353 | W | y | −432.464 | X | y | −433.91 | Y | y | −434.42 |
| | z | 7.19056E−19 | | z | 194.16 | | z | 389.078 | | z | 581.436 | | z | 774.568 |

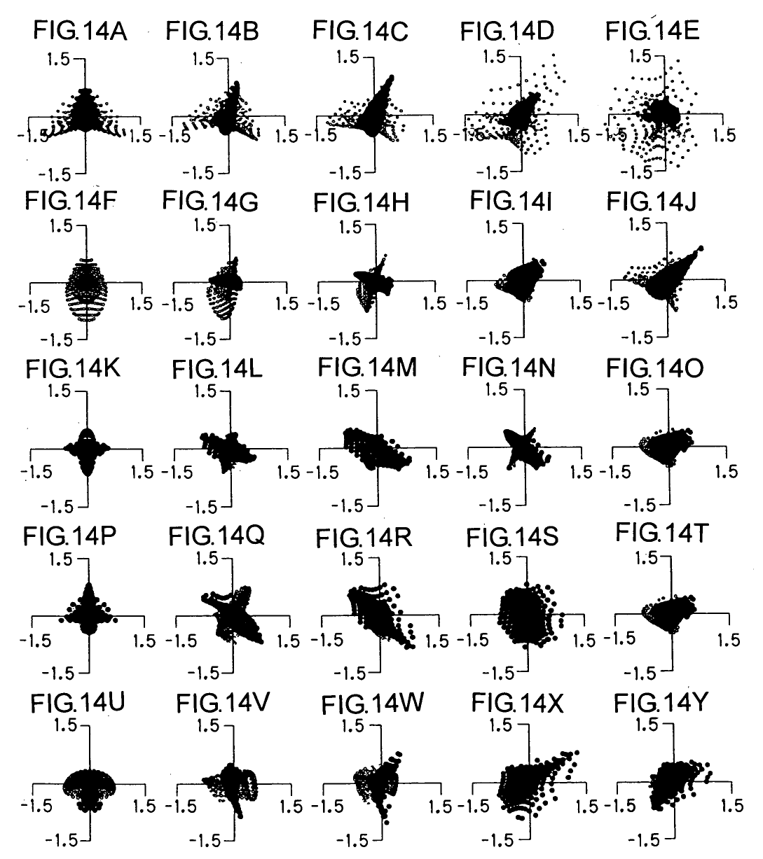

TABLE 31

| | |
|---|---|
| Example 4 | Projected Spot Barycenter Positions (FIG. 14) |

| | | | | | | | | | | | | | | |
|---|---|---|---|---|---|---|---|---|---|---|---|---|---|---|
| A | y | 500.076 | B | y | 499.565 | C | y | 498.548 | D | y | 499.455 | E | y | 501.451 |
| | z | 9.59225E−19 | | z | 222.243 | | z | 444.164 | | z | 667.009 | | z | 891.197 |
| F | y | 250.604 | G | y | 250.724 | H | y | 250.688 | I | y | 249.256 | J | y | 247.003 |
| | z | 6.97376E−19 | | z | 221.924 | | z | 443.916 | | z | 665.447 | | z | 886.362 |
| K | y | −0.227601 | L | y | −0.142693 | M | y | −0.0666761 | N | y | 0.0619951 | O | y | −1.18547 |
| | z | −8.54018E−19 | | z | 220.631 | | z | 441.669 | | z | 663.84 | | z | 885.858 |
| P | y | −252.958 | Q | y | −250.73 | R | y | −248.318 | S | y | −248.889 | T | y | −1.18547 |
| | z | 7.11681E−19 | | z | 217.962 | | z | 439.433 | | z | 661.302 | | z | 885.858 |
| U | y | −505.81 | V | y | −501.897 | W | y | −496.407 | X | y | −496.322 | Y | y | −498.679 |
| | z | −1.86955E−18 | | z | 209.671 | | z | 434.094 | | z | 659.865 | | z | 882.166 |

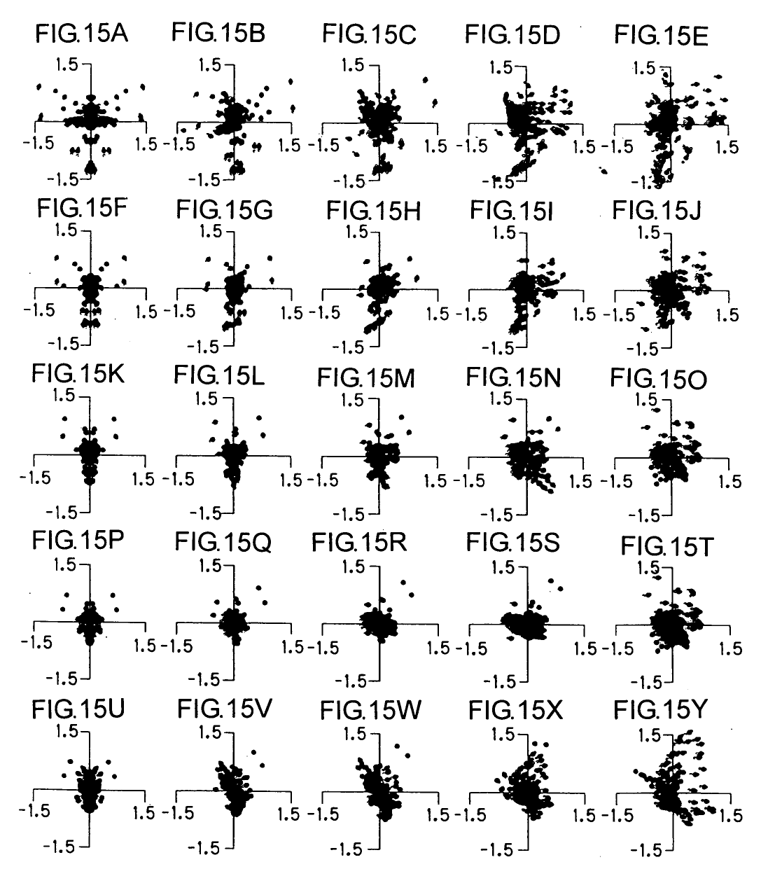

TABLE 32

| | |
|---|---|
| Example 5 | Projected Spot Barycenter Positions (FIG. 15) |

| | | | | | | | | | | | | | | |
|---|---|---|---|---|---|---|---|---|---|---|---|---|---|---|
| A | y | 341.421 | B | y | 340.591 | C | y | 338.949 | D | y | 338.271 | E | y | 339.598 |
| | z | −2.27738E−18 | | z | 122.515 | | z | 249.003 | | z | 379.862 | | z | 512.674 |
| F | y | 171.564 | G | y | 170.766 | H | y | 169.223 | I | y | 168.535 | J | y | 169.101 |
| | z | −5.69345E−19 | | z | 124.83 | | z | 251.013 | | z | 378.411 | | z | 506.267 |
| K | y | 0.277979 | L | y | 0.269352 | M | y | 0.486668 | N | y | 0.955999 | O | y | 0.684872 |
| | z | −7.11681E−20 | | z | 125.876 | | z | 251.556 | | z | 377.203 | | z | 503.551 |
| P | y | −168.425 | Q | y | −168.22 | R | y | −167.841 | S | y | −168.012 | T | y | 0.684872 |
| | z | −1.28103E−18 | | z | 125.816 | | z | 251.368 | | z | 377.185 | | z | 503.551 |
| U | y | −341.39 | V | y | −341.289 | W | y | −341.043 | X | y | −340.857 | Y | y | −339.736 |
| | z | −5.69345E−19 | | z | 126.219 | | z | 252.278 | | z | 378.38 | | z | 503.701 |

What is claimed is:

1. A projection optical system for performing enlargement projection from a primary image surface located on a reduction side to a secondary image surface located on an enlargement side, the projection optical system comprising, from a secondary image surface side, at least two reflective surfaces,
wherein, of a first and a second reflective surface counted from the secondary image surface side, at least one has a negative optical power, and
wherein at least one Fresnel reflective surface having a positive or negative optical power is disposed within the entire projection optical system.

2. The projection optical system of claim 1,
wherein the second reflective surface counted from the secondary image surface side has a negative optical power.

3. The projection optical system of claim 1,
wherein the Fresnel reflective surface has a negative optical power.

4. The projection optical system of claim 1,
wherein the second reflective surface counted from the secondary image surface side is a Fresnel reflective surface having a negative optical power.

5. The projection optical system of claim 1,
wherein the first reflective surface counted from the secondary image surface side is a Fresnel reflective surface having a positive optical power.

6. The projection optical system of claim 1,
wherein a line normal to a macroscopic surface of the Fresnel reflective surface is substantially parallel to a line normal to the secondary image surface.

7. The projection optical system of claim 1, further comprising:
a refractive optical element disposed in an optical path on a primary image surface side of the Fresnel reflective surface.

8. A projection optical system for projecting, while enlarging, an image formation surface of a light valve onto a screen surface, the light valve forming a two-dimensional image, the projection optical system comprising:
a flat mirror for turning an optical path; and
a Fresnel mirror having an optical power, the Fresnel mirror being disposed on an image formation surface side of the flat mirror.

9. The projection optical system of claim 8,
wherein the Fresnel mirror has a negative optical power.

10. The projection optical system of claim 8,
wherein the flat mirror is parallel to the screen surface.

11. The projection optical system of claim 8, further comprising:
a refractive optical system disposed on the image formation surface side of the Fresnel mirror.

12. The projection optical system of claim 11, further comprising:
a flat mirror disposed between the Fresnel mirror and the refractive optical system.

13. The projection optical system of claim 8, further comprising:
three reflective surfaces each having an optical power and disposed on an image formation surface side of the Fresnel mirror.

14. The projection optical system of claim 13,
wherein a most image formation surface side reflective surface has a positive optical power, and a second reflective surface counted from the image formation surface side has a negative optical power.

15. The projection optical system of claim 13,
wherein a third reflective surface counted from the image formation surface side has a non-rotation-symmetric shape.

16. The projection optical system of claim 13, further comprising:
a refractive optical element having a non-rotation-symmetric surface, the refractive optical element being disposed between a most image formation surface side reflective surface and a second reflective surface counted from the image formation surface side.

17. A projection optical system for projecting, while enlarging, an image formation surface of a light valve onto a screen surface, the light valve forming a two-dimensional image, the projection optical system comprising, from the screen surface side:
a Fresnel reflective surface having a positive optical power; and
a reflective surface having an optical power.

18. The projection optical system of claim 17,
wherein the reflective surface having an optical power is a reflective surface having a negative optical power.

19. The projection optical system of claim 18,
wherein the reflective surface having a negative optical power is a Fresnel reflective surface.

20. The projection optical system of claim 18, further comprising:
a reflective surface having a positive optical power and disposed on an image formation surface side of the reflective surface having a negative optical power.

21. The projection optical system of claim 17, further comprising:
a refractive optical system disposed on an image formation surface side of the reflective surface.

22. The projection optical system of claim 17,
wherein a macroscopic surface of the Fresnel reflective surface having a positive optical power is parallel to the screen surface.
